(19) United States
(12) Patent Application Publication
(10) Pub. No.: US 2025/0205996 A1
(43) Pub. Date: Jun. 26, 2025

(54) RESIN-METAL COMPOSITE PANEL

(71) Applicant: NIPPON STEEL CORPORATION, Tokyo (JP)

(72) Inventors: Nobuo KADOWAKI, Tokyo (JP); Miyeong PARK, Tokyo (JP); Tomohiro MIZUTANI, Tokyo (JP); Tomoya HARA, Tokyo (JP); Yuta TAJIMA, Tokyo (JP)

(73) Assignee: NIPPON STEEL CORPORATION, Tokyo (JP)

(21) Appl. No.: 18/851,602

(22) PCT Filed: Apr. 4, 2023
(86) PCT No.: PCT/JP2023/013941

§ 371 Date: Sep. 26, 2024

(30) Foreign Application Priority Data
Apr. 4, 2022 (JP) 2022-062227

(51) Int. Cl. B32B 15/04; B32B 5/18; B32B 15/18; B32B 15/20

(52) U.S. Cl. CPC B32B 15/04; B32B 5/18; B32B 15/18; B32B 15/20; B32B 2266/0278; B32B 2307/72; B32B 2307/7376; B32B 2419/04

(57) ABSTRACT

To inexpensively manufacture a lightweight, highly rigid resin-metal composite panel having excellent corrosion resistance and high rigidity, as laminated panels for floor and wall materials of building materials, ships, and vehicles. A resin-metal composite panel is a resin-metal composite panel formed by injecting and foaming a hard urethane resin between skin materials made of two metal sheets, in which the skin material is a single-sided film-laminated steel sheet having a steel sheet thickness of 0.1 mm or more or a single-sided film-laminated aluminum sheet having a sheet thickness of 0.24 mm or more, including: a thermoplastic resin layer having a specific thickness on a panel outer surface side; and a layer having a surface tension of 50 mN/m or more, the layer made of inorganic hydrated oxide and inorganic oxide with a specific adhesion amount on an inner surface side to be bonded to a core resin layer, and the hard foamed urethane resin of the core layer has a thickness of 3 mm or more, a dynamic longitudinal elastic modulus measured at 80° C. and 1 Hz of 100 MPa or more, and a density of the hard foamed urethane resin after foaming falling within a specific range.

### TECHNICAL FIELD

The present invention relates to a material for laminated panels used as the measures to reduce the weight of floor and wall materials of building materials, ships, and vehicles and particularly relates to a laminated panel including a foamed resin core layer between two metal sheets.

### BACKGROUND ART

As the measures to reduce the weight of floor and wall materials of building materials, ships, and vehicles, a laminated lightweight panel including, as a core layer, a foamed resin layer or an aluminum honeycomb paper honeycomb layer bonded and laminated between two metal sheets, has been proposed and put into practical use.

As the resin-metal composite panel using a foamed resin for the core layer, there has been cited an example of a foamable resin laminated metal sheet in which an adhesive layer and a non-foamable resin layer are provided in order from the metal sheet side between a metal sheet and a foamable resin as described in Patent Document 1. Further, as the laminated panel using a honeycomb for the core layer, there has been cited an example of a sandwich panel in which sheet-like prepregs are cured on both surfaces of a sheet-like core layer having a honeycomb structure, as described in Patent Document 2.

Even in the case of the resin-metal composite panel using the foamed resin for the core layer, if the adhesive strength between a skin metal sheet and the core layer is low, the interface between the core layer and the skin metal sheet may peel off when the panel is subjected to an impact or large load. Therefore, it is necessary to increase the adhesive strength between the core layer and the skin sheet.

In Patent Document 3, there has been described an example of a resin sheet laminated steel sheet, consisting of, on both surfaces of a resin sheet (a), a resin sheet (b) with a metal sheet embedded therein and a steel sheet located on the surface of the resin sheet (b) opposite to the other surface in contact with the resin sheet (a) laminated at least sequentially. Further, Patent Document 3 has described that the metal sheet to be embedded in the resin sheet (b) has fine pore portions having a volume fraction of 30 vol % or more to the total volume of the metal sheet formed therein.

Patent Document 4 has described a method of manufacturing a laminated panel by applying a primer or paint to the surface of a metal sheet that comes into contact with a hard foamed urethane resin.

### PRIOR ART DOCUMENT

### Patent Document

Patent Document 1: Japanese Patent No. 4326001
Patent Document 2: Japanese Laid-open Patent Publication No. 2018-187939
Patent Document 3: Japanese Patent No. 5553542
Patent Document 4: Japanese Patent No. 4044724

### DISCLOSURE OF THE INVENTION

### Problems to be Solved by the Invention

Incidentally, in such a laminated panel as described in Patent Document 1, a non-foamable resin layer is bonded with an adhesive to be laminated between the metal sheet and the foamed resin in order to inhibit the foamed resin layer and the metal sheet from peeling off. In this case, manufacturing costs are high because a large number of steps for bonding with an adhesive are required and a foaming step is required separately.

Further, Patent Document 2 has described a method for manufacturing the sandwich panel in which sheet-like prepregs are heated and pressurized while being pressed from an upper surface and a lower surface of a sheet-like core layer having a honeycomb structure. Here, the honeycomb material of the core layer and the prepreg of a skin material of the sandwich panel are expensive and the heating time is long, resulting in that the material cost and the manufacturing cost are both high.

The laminated panel described in Patent Document 3 is a resin sheet laminated steel sheet, consisting of, on both surfaces of a resin sheet (a), a resin sheet (b) with a metal sheet embedded therein and a steel sheet located on the surface of the resin sheet (b) opposite to the other surface in contact with the resin sheet (a) laminated at least sequentially. There is a need for a step of forming in advance fine pores having a volume fraction of 30 vol % or more to the total volume of the metal sheet in the metal sheet embedded in the resin sheet (b), and thus the cost of the resin sheet (b) in the laminated panel is high. Therefore, there is room for improvement in terms of making laminated panels less expensive.

Further, the resin sheet laminated steel sheet in Patent Document 3 is intended for application to automobile outer panels, housings of home appliances, furniture, and OA equipment parts, and therefore needs to be capable of being subjected to bending or deep drawing. Therefore, the resin sheet (a), which is the core layer, is flexible and relatively thin with a preferred thickness of 0.2 to 1.5 mm, and the total thickness of the panel is about 3 mm or less. Therefore, the resin sheet laminated steel sheet in Patent Document 3 is not suitable for applications that require a high load capacity and about 5 mm or more of at least the thickness of the core layer, such as laminated panels for building materials, ships, and vehicles.

Patent Document 4 has described a method of manufacturing a laminated panel by applying a primer or paint to the surface of a metal sheet that comes into contact with a hard foamed urethane resin. Such a manufacturing method requires the application of a primer to the metal sheet, followed by drying and baking. Further, in order to stabilize the adhesive strength between the metal sheet and the hard foamed resin, it is necessary to prevent oxidation of the surface of the metal sheet or insufficient curing of a primer coating film, resulting in that quality control in an adhesive state is complicated. Further, by applying the primer or paint to the surface of the metal sheet that comes into contact with the hard foamed urethane resin, an improvement in adhesion to the urethane resin is expected. However, when a urethane resin liquid is injected between the two metal sheets, the primer layers are softened by the reaction heat of the urethane resin liquid, resulting in that the flow resistance of the urethane resin liquid increases to make it easier for the urethane resin to stay. As a result, foamed foams tend to meet at a stagnation point to be huge. For this reason, in the case of the panel including a thin hard foamed urethane resin layer, the rigidity of a portion where huge foam is present decreases, making the panel more likely to buckle.

Further, Patent Document 4 has described that a steel sheet obtained by performing a plating treatment such as galvanizing on both surfaces is used as the skin steel sheet. However, in the case of the steel sheet obtained by galvanizing the outer surface side of the skin steel sheet of the panel, if salt water or water is applied to the panel, the salt water or water can reach the galvanized surface through a carpet fabric attached to the top surface, causing the galvanization to corrode and swell. Zinc corrosion products are brittle, and thus a covering such as a carpet attached to the outer surface side of the panel is likely to peel off.

The present invention is the invention made in consideration of the above-described problems, and an object thereof is to provide an inexpensive laminated panel having excellent impact resistance, which is a metal-resin composite panel with a high buckling strength that is capable of inhibiting instability of an adhesive strength, which is likely to occur in the panel manufacturing method described in Patent Document 4 in particular, inhibiting air foams in a hard foamed resin layer from becoming huge, and stably obtaining a high adhesive strength between a metal sheet and a hard foamed urethane resin.

### Means for Solving the Problems

In order to solve the previously-described problems and object, the present invention has made it possible to inexpensively provide a laminated panel that has a high adhesive strength with a core resin layer of the laminated panel and has excellent impact resistance by optimizing the compositions of a skin material of the laminated panel using a hard foamed urethane resin as the core resin layer and the foamed hard urethane resin of the core resin layer. The present invention does not include extra manufacturing steps such as heat-compression bonding of a prepreg sheet to a honeycomb core layer, or the like, and thus is capable of providing a laminated panel inexpensively, has an excellent adhesive strength between the core resin layer and the skin material, and is capable of making variations in foam size of the core resin layer small. This makes it possible to manufacture the laminated panel having high impact resistance inexpensively.

The present invention has been made based on the above findings and the gist thereof is as follows.

(1) A resin-metal composite panel formed by injecting and foaming a hard urethane resin between skin materials made of two metal sheets, in which the skin material is a single-sided film-laminated steel sheet having a steel sheet thickness of 0.1 mm or more, the single-sided film-laminated steel sheet including: a thermoplastic resin layer having a film thickness of 8 μm to 150 μm on a panel outer surface side; and a layer having a surface tension of 50 mN/m or more as a surface tension measured based on JIS K 6768: 1999, the layer made of inorganic hydrated oxide and inorganic oxide with 1.5 to 130 mg/m² on an inner surface side to be bonded to a core resin layer, or a single-sided film-laminated aluminum sheet having an aluminum sheet thickness of 0.24 mm or more, the single-sided film-laminated aluminum sheet including: a thermoplastic resin layer having a film thickness of 8 μm to 150 μm on a panel outer surface side; and a layer having a surface tension of 50 mN/m or more as a surface tension measured based on JIS K 6768: 1999, the layer made of inorganic hydrated oxide and inorganic oxide with 1.5 to 130 mg/m² on an inner surface side to be bonded to a core resin layer, and the hard urethane resin of the core resin layer has a thickness of 3 mm or more, a dynamic longitudinal elastic modulus measured at 80° C. and 1 Hz of 100 MPa or more, and a density of the hard foamed urethane resin after foaming of 0.2 to 0.7 g/cm³.
(2) The resin-metal composite panel according to (1), in which the inorganic hydrated oxide and inorganic oxide on the skin material are inorganic hydrated oxide and inorganic oxide containing one or two or more selected from the group consisting of chromium hydrated oxide and chromium oxide, zirconium hydrated oxide and zirconium oxide, titanium hydrated oxide and titanium oxide, tungsten hydrated oxide and tungsten oxide, cerium hydrated oxide and cerium oxide, and silica.
(3) The resin-metal composite panel according to (1) or c(2), in which a thermoplastic film having a surface tension of 40 mN/m or more is thermally fusion-bonded to the panel outer surface side of the single-sided film-laminated steel sheet or the single-sided film-laminated aluminum sheet.
(4) The resin-metal composite panel according to (3), in which the thermoplastic film is a resin blended with one or two or more selected from the group consisting of a thermoplastic polyester resin, a polyethylene resin with modified resin layer, a polypropylene resin with modified resin layer, an ethylene-propylene copolymer resin with modified resin layer, an ionomer resin, and a polyvinyl chloride resin.

### Effect of the Invention

The resin-metal laminated panel of the present invention makes it possible to inexpensively provide a lightweight, highly rigid panel that has a high adhesive strength between a core layer and a skin material of the resin-metal laminated panel and stable rigidity and strength of the panel. Such a resin-metal composite panel is extremely useful as a laminated lightweight panel for floor and wall materials of building materials, ships, and vehicles.

### BRIEF DESCRIPTION OF THE DRAWINGS

FIG. 1 is a view illustrating the relationship between a thickness of a skin material of a resin-metal composite panel and dent resistance of a laminated panel.

FIG. 2 is a view illustrating the relationship between film wrinkle resistance when manufacturing a resin film-laminated steel sheet that is the skin material of the resin-metal composite panel and a film thickness.

FIG. 3 is a view illustrating the relationship between film burr resistance when cutting the laminated steel sheet during manufacture of the resin film-laminated steel sheet that is the skin material of the resin-metal composite panel and a film thickness.

FIG. 4 is a view illustrating the relationship between a surface tension on the inner surface side of a panel skin of the resin-metal composite panel and adhesiveness between the skin material and a foamed hard urethane resin layer of the panel.

FIG. 5 is a view illustrating the relationship between an adhesion amount of inorganic hydrated oxide and inorganic oxide on the inner surface side of the skin material of the resin-metal composite panel and impact resistance of the panel.

FIG. 6 is a view illustrating the relationship between a dynamic elastic modulus at 80° C. and 1 Hz of the foamed urethane resin layer resin of the resin-metal composite panel and bending resistance of the panel at 80° C.

FIG. 7 is a view illustrating the relationship between a thickness of the foamed urethane resin layer of the resin-metal composite panel and impact resistance of the panel.

FIG. 8 is a view illustrating the relationship between a density of the foamed urethane resin layer of the resin-metal composite panel and impact resistance of the panel.

FIG. 9 is a schematic cross-sectional view of a resin-metal laminated panel using resin film-laminated metal sheets.

### EMBODIMENTS FOR CARRYING OUT THE INVENTION

There is explained a preferred embodiment of the present invention in detail with reference to the attached drawings below.

### <<Regarding a Resin-Metal Composite Panel>>

A resin-metal composite panel according to an embodiment of the present invention includes a pair of skin materials made of two metal sheets and a core resin layer located between the pair of skin materials and formed of a hard urethane resin in a foamed state (to be sometimes referred to as “foamed hard urethane resin” below).

### <Skin Material>

There is explained in detail a composition of the skin material that forms the resin-metal composite panel according to the embodiment of the present invention below.

The base material of the skin material forming the resin-metal composite panel (to be sometimes abbreviated as “panel” simply below) according to this embodiment is preferably a metal sheet from the viewpoint of excellent strength, rigidity, workability, adhesiveness, and cost, and is more preferably a steel sheet in particular, or an aluminum sheet from the viewpoint of strength, workability, cost, and the like. Such a skin material is also referred to as “skin metal sheet” below.

When a steel sheet is used as the skin material of the resin-metal composite panel, the mechanical properties (for example, strength and elongation) of the steel sheet may be appropriately determined within a range that does not impair cuttability⋅workability.

Being expected to be used in various environments, the resin-metal composite panel according to this embodiment preferably has corrosion resistance equivalent to that of a building material panel. Therefore, it is desirable to coat the outer surface side of the panel with resin. However, coating the surface of the panel with resin after the panel is manufactured increases the manufacturing cost. Therefore, as the steel sheet to be used for the skin material, it is preferable to use a laminated steel sheet whose surface is coated with resin in advance. Examples of the method of coating the surface of the steel sheet with resin include a method of applying a resin paint, a resin film lamination method of thermally fusion-bonding a thermoplastic resin film to the steel sheet, and so on. The method of thermally laminating a thermoplastic resin film is suitable as the method of coating the surface of the steel sheet with resin, from the viewpoint that there is no need for additional facilities such as a drying furnace and there is no risk of environmental pollution due to solvents.

Regarding the thickness of the skin metal sheet, in the case where the skin metal sheet is a steel sheet, if the thickness is less than 0.1 mm, the skin metal sheet may be locally dented or a hole may be formed in the skin metal sheet when a hard, angular, heavy object is dropped on the resin-metal composite panel. Therefore, when the steel sheet is used as the skin metal sheet, the thickness of the steel sheet is set to 0.10 mm or more. For the same reason, when an aluminum sheet is used as the skin metal sheet, the thickness of the aluminum sheet is set to 0.24 mm or more.

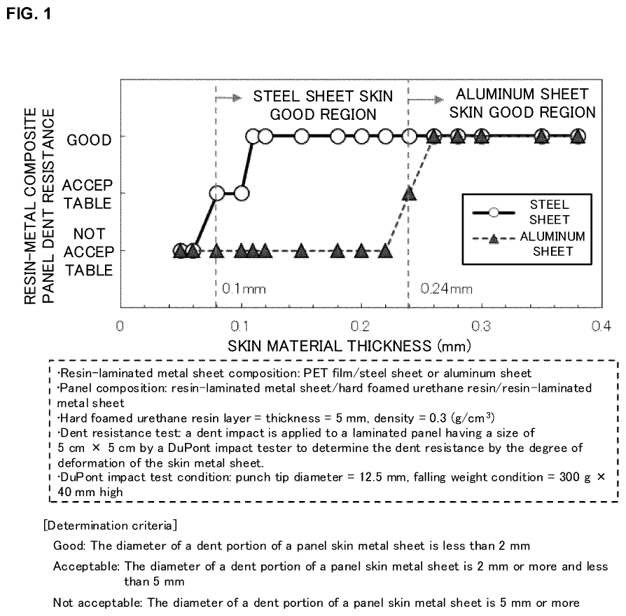

FIG. 1 illustrates the relationship between a thickness of the skin metal sheet of the resin-metal composite panel and dent resistance of the panel. The vertical axis of a graph chart illustrated in FIG. 1 indicates an evaluation result of the dent resistance of the resin-metal composite panel, and the horizontal axis of the graph chart illustrated in FIG. 1 indicates a thickness of the skin material (unit: mm).

Here, the composition of the resin-laminated metal sheet used as the skin material when evaluating the above-described dent resistance is the composition of “PET film/steel sheet or aluminum sheet,” and the composition of the resin-metal composite panel is the composition of “resin-laminated metal sheet/hard foamed urethane resin/resin-laminated metal sheet.” Further, the hard foamed urethane resin layer has a thickness of 5 mm and a density of 0.3 g/cm³.

In a dent resistance test, a dent impact was applied to a panel having a size of 5 cm×5 cm using a DuPont impact tester, and the dent resistance was determined by the degree of deformation of the skin material. Here, the test conditions for the DuPont impact test were punch tip diameter: 12.5 mm, and falling weight condition: 300 g×40 mm high.

Further, the determination criteria for the test results obtained are as follows.

Good: The diameter of a dent portion of the skin metal sheet in the panel is less than 2 mm

Acceptable: The diameter of a dent portion of the skin metal sheet in the panel is 2 mm or more and less than 5 mm

Not acceptable: The diameter of a dent portion of the skin metal sheet in the panel is 5 mm or more

As can be seen from FIG. 1, when the skin metal sheet is a steel sheet, the dent resistance of the steel sheet skin is ensured as long as the sheet thickness is 0.10 mm or more. Further, it can be seen that when the skin metal sheet is an aluminum sheet, the dent resistance of the aluminum sheet skin can be ensured as long as the sheet thickness is 0.24 mm or more.

From the viewpoint of panel rigidity, the upper limit of the thickness of the skin metal sheet is not limited in particular. However, from the viewpoint of lightweight and high rigidity, which is the object of the resin-metal composite panel, an excessively thick skin material is not preferable because the merit of weight reduction is lost. Therefore, in the case of the skin metal sheet being a steel sheet, the upper limit of the thickness is desirably about 1.0 mm or less, and in the case of the skin metal sheet being an aluminum sheet, the upper limit of the thickness is desirably about 3.0 mm or less.

The surface of the skin metal sheet on the side to be bonded to the foamed hard urethane resin (namely, the core resin layer) is preferably cleaned in advance by alkaline degreasing⋅water washing⋅drying before bonding in order to stabilize the adhesiveness to the urethane resin.

The aluminum sheet, in particular, has poor adhesiveness to resins due to an oxide coating film on the surface, in a state where the oxide coating film remains present. Therefore, when the aluminum sheet is used as the skin metal sheet, it is preferable to remove the oxide coating film on the surface by alkaline degreasing, polishing, and the like and keep the aluminum sheet clean. Then, by providing such a layer made of inorganic hydrated oxide and inorganic oxide as will be described later on the surface, a urethane bonding portion of the urethane resin and a hydroxyl group of a chromium hydrate that can be contained in such a layer made of inorganic hydrated oxide and inorganic oxide as will be described later are hydrogen bonded and strong adhesion is obtained, which is preferable.

Next, the resin layer located on the skin metal sheet of the resin-metal composite panel according to this embodiment is described.

As the resin to be laminated to the surface of the skin metal sheet of the resin-metal composite panel according to this embodiment (more precisely, the surface of the skin metal sheet that serves as the panel outer side of the resin-metal composite panel), a thermoplastic resin film is preferable because of its ease of thermal lamination.

As a thermoplastic resin having high adhesion to the skin metal sheet and high water resistance, there are resins that have polar groups capable of hydrogen bonding in their molecular chains, such as, for example, a polyester resin, a polyamide resin, an ionomer resin, modified polyolefin (polyethylene, polypropylene) resins, and a vinyl chloride resin. Using these resins makes it possible to improve the adhesiveness between the metal sheet and the resin.

In particular, it is more preferable to use polyester resin films (homo-PET (polyethylene terephthalate resin) film, PET-IA (polyethylene terephthalate⋅isophthalate copolymer resin) film, PBT (polybutylene terephthalate copolymer resin) film, and copolymerized or blended resin film of these resins) and modified polyolefin resin films with a modified resin layer on an adhesive surface (polyethylene, polypropylene, polyethylene-polypropylene copolymer), from the viewpoint of a fusion property with the metal sheet, an adhesion strength, and corrosion resistance. Therefore, the thermoplastic resin film that is provided on the surface of the skin metal sheet to serve as the panel outer side and functions as a thermoplastic resin layer is preferred to be a resin blended with one or two or more selected from a thermoplastic polyester resin, a polyethylene resin with modified resin layer, a polypropylene resin with modified resin layer, an ethylene-propylene copolymer resin with modified resin layer, an ionomer resin, and a polyvinyl chloride resin.

Further, such a thermoplastic resin film as described above may contain an inorganic filler or a color pigment such as titanium white, silica, or carbon black.

As explained above, the film to be laminated to the surface on the outer surface side of the skin metal sheet of the resin-metal composite panel according to this embodiment is set to be thermoplastic. This is because the thermoplastic film more easily fuses with a hot melt adhesive when a nonwoven fabric or a carpet is further attached to the surface of the resin-metal composite panel according to this embodiment with the hot melt adhesive, as necessary. Further, the thermoplastic film that is provided on the surface on the outer surface side of the resin-metal composite panel according to this embodiment and functions as a thermoplastic resin layer preferably has thermoplasticity with a surface tension of 40 mN/m or more. The case where the surface tension of the film is less than 40 mN/m is not preferable because when an impact is applied to the panel, the film on the surface of the panel is likely to peel off and the rust prevention ability of the panel may decrease. Incidentally, such a surface tension is the surface tension measured based on the method specified in JIS K 6768: 1999 “Plastics-Film and sheeting-Determination of wetting tension.”

The thickness of the thermoplastic resin layer to be provided on the surface on the outer surface side of the skin metal sheet of the resin-metal composite panel is 8 μm or more and 150 μm or less. The case where the thickness of the thermoplastic resin layer is less than 8 μm is not preferable because when laminating the thermoplastic film, the film is likely to wrinkle and when a wrinkle portion is laminated, not only does an appearance of the film become ugly, but the film breaks easily and the metal sheet may corrode. Further, the case where the thickness of the thermoplastic resin layer exceeds 150 μm is not preferable because when cutting the laminated metal sheet, the film remains uncut and easily peels off at a cut end surface.

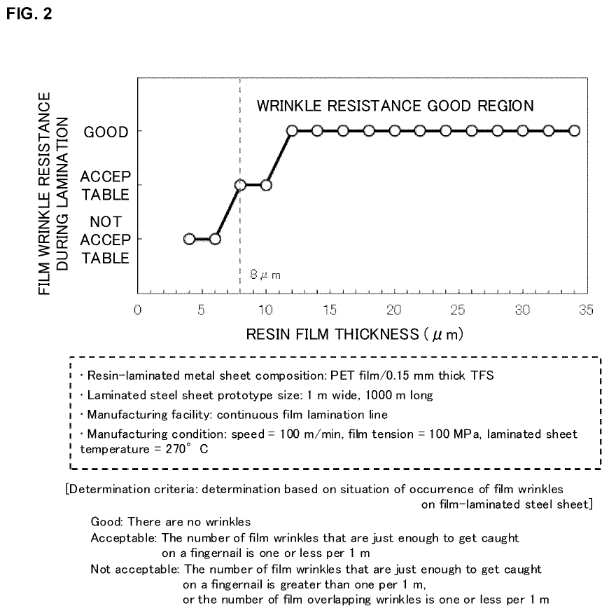

FIG. 2 illustrates the relationship between the degree of wrinkles that have occurred on a film laminated surface when a stretched homo-PET film is continuously thermally fusion-bonded to a 0.15 mm thick TFS (tin-free steel) steel sheet for 1000 m while applying tension thereto in a continuous film lamination facility and a film thickness. The vertical axis of a graph chart illustrated in FIG. 2 indicates an evaluation result of film wrinkle resistance during lamination, and the horizontal axis of the graph chart illustrated in FIG. 2 indicates a resin film thickness (unit: μm).

Here, the composition of the resin-laminated metal sheet used in evaluating the above-described film wrinkle resistance is the composition of “PET film/0.15 mm thick TFS”, and the size of a prototype of the laminated steel sheet is 1 m wide×1000 m long. Such a laminated steel sheet was manufactured using a continuous film lamination line. The manufacturing conditions were: speed: 100 m/min, film tension: 100 MPa, and laminated sheet temperature: 270° C.

Further, the results obtained were determined based on the situation of occurrence of film wrinkles on the film-laminated steel sheet. The determination criteria are as follows.

Good: There are no wrinkles

Acceptable: The number of film wrinkles that are just enough to get caught on a fingernail is one or less per 1 m

Not acceptable: The number of film wrinkles that are just enough to get caught on a fingernail is greater than one per 1 m, or the number of film overlapping wrinkles is one or less per 1 m

As can be seen from FIG. 2, it became clear that the case where the film thickness is less than 8 μm is not preferable because overlapping wrinkles are likely to occur on the surface of the laminated film. Therefore, the thickness of the thermoplastic film to be laminated to the skin material was set to 8 μm or more.

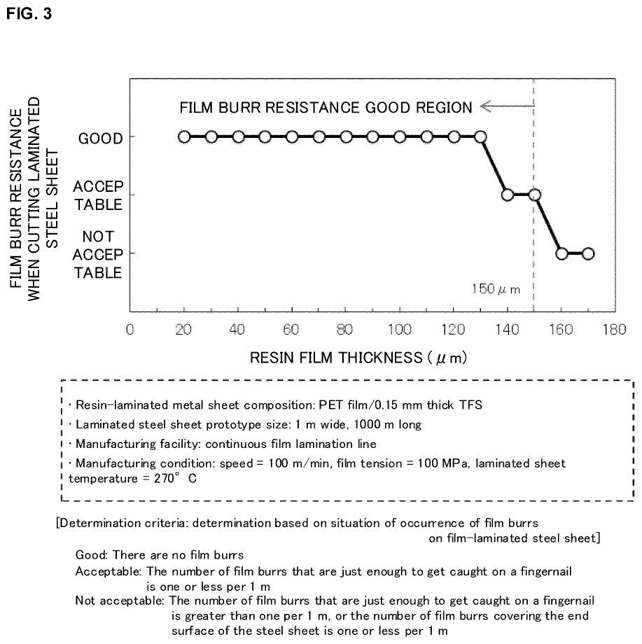

FIG. 3 is a view illustrating the relationship between a film burr property to occur when cutting, using a shearing machine, a film-laminated steel sheet made by thermally fusion-bonding a homo-PET film to both surfaces of a 0.15 mm thick TFS in a continuous line and a film thickness. The vertical axis of a graph chart illustrated in FIG. 3 indicates an evaluation result of film burr resistance during lamination, and the horizontal axis of the graph chart illustrated in FIG. 3 indicates a resin film thickness (unit: μm).

Here, the composition of the resin-laminated metal sheet used in evaluating the above-described film burr resistance is the composition of “PET film/0.15 mm thick TFS”, and the size of a prototype of the laminated steel sheet is 1 m wide×1000 m long. Such a laminated steel sheet was manufactured using a continuous film lamination line. The manufacturing conditions were: speed: 100 m/min, film tension: 100 MPa, and laminated sheet temperature: 270° C.

Further, the results obtained were determined based on the situation of occurrence of film burrs on the film-laminated steel sheet. The determination criteria are as follows.

Good: There are no film burrs

Acceptable: The number of film burrs that are just enough to get caught on a fingernail is one or less per 1 m

Not acceptable: The number of film burrs that are just enough to get caught on a fingernail is greater than one per 1 m, or the number of film burrs covering the end surface of the steel sheet is one or less per 1 m

As can be seen from FIG. 3, it became clear that when the film thickness exceeds 150 μm, burrs of the film are more likely to occur. Film peeling is likely to occur near a cut end surface because force acts in the direction in which the film is torn off on the lower end side of the cut end surface, in particular. In such a case, if moisture adheres to the end surface, the moisture permeates the interface between the film and the steel sheet, making the steel sheet surface susceptible to rust, which is not preferable.

Based on the above, the thickness of the thermoplastic film to be laminated to the surface of the skin metal sheet of the resin-metal composite panel according to this embodiment is set to 8 μm or more and 150 μm or less.

Next, there is described a coating film containing inorganic hydrated oxide and inorganic oxide on the skin material of the resin-metal composite panel.

In the skin metal sheet of the resin-metal composite panel according to this embodiment, the coating film containing inorganic hydrated oxide and inorganic oxide (to be sometimes abbreviated as “inorganic coating film” simply below) is located on the surface of the side in contact with the hard foamed urethane resin layer (namely, the core resin layer).

The coating film containing the inorganic hydrated oxide exists on the side of the skin metal sheet of the resin-metal composite panel that is in contact with the hard foamed urethane resin, and thereby the hydroxyl group of the inorganic hydrated oxide is hydrogen bonded to a urethane bonding portion of the hard foamed urethane resin, to make it possible to achieve strong adhesion, which is preferable.

The surface tension of the coating film containing the inorganic hydrated oxide and inorganic oxide is 50 mN/m or more when measured by a measurement method based on JIS K 6768: 1999 “Plastics-Film and sheeting-Determination of wetting tension.” Here, such a surface tension is measured by focusing on the wettability of a wetting tension test mixture (manufactured by FUJIFILM Wako Pure Chemical Corporation, for example).

The case where the surface tension of the inorganic coating film located on the surface of the skin metal sheet of the resin-metal composite panel on the side that is in contact with the hard foamed urethane resin is less than 50 mN/m is not preferable because in a load capacity test in which a heavy object is placed on the panel, or in an impact resistance test in which a heavy object is dropped from the top of the panel, interfacial peeling between the skin metal sheet and the hard foamed urethane resin occurs easily, which may cause rapid buckling deformation of the panel. By setting the surface tension of the inorganic coating film to 50 mN/m or more, the interfacial peeling between the skin metal sheet and the hard foamed urethane resin can be prevented.

On the other hand, regarding the surface tension of the inorganic coating film located on the surface of the skin metal sheet of the resin-metal composite panel on the side that is in contact with the hard foamed urethane resin, even if the surface of the metal sheet is degreased and cleaned to increase the surface tension and the surface tension is precisely measured by a contact angle method or the like, the effect of improving the adhesiveness between the surface metal sheet and the hard foamed urethane resin becomes saturated after the surface tension exceeds the threshold value of 70 mN/m. Therefore, the surface tension of the inorganic coating film located on the surface of the skin metal sheet of the resin-metal composite panel on the side that is in contact with the hard foamed urethane resin is preferably 70 mN/m or less, which is measured according to JIS K 6768: 1999 “Plastics-Film and sheeting-Determination of wetting tension” industrially.

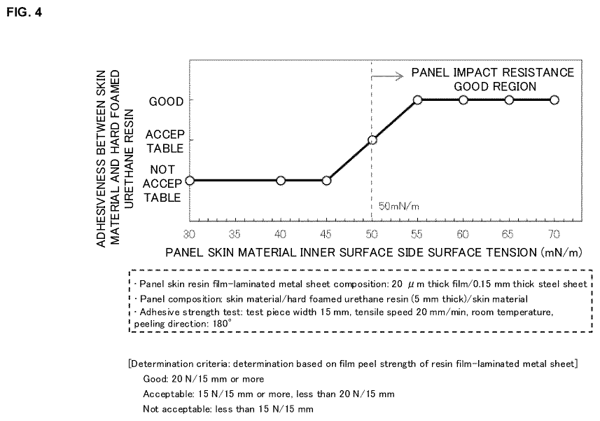

FIG. 4 is a view illustrating the relationship between a surface tension on the inner surface side of a panel skin of a resin-metal composite panel made by injecting and solidifying a hard foamed urethane resin between two cold-rolled steel sheet skin materials and adhesiveness between the skin material and the hard foamed urethane resin layer of the panel. Here, the surface of the cold-rolled steel sheet skin material used was degreased and then subjected to various conversion treatments by varying the adhesion amount within the range of 2 to 50 mg/m², and thereby the value of surface tension was varied. The vertical axis of a graph chart illustrated in FIG. 4 indicates an evaluation result of the adhesiveness between the skin material and the hard foamed urethane resin, and the horizontal axis of the graph chart illustrated in FIG. 4 indicates a surface tension on the inner surface side of the panel skin material (unit: mN/m).

Here, the composition of the resin film-laminated metal sheet used in evaluating the above-described adhesiveness is the composition of “20 μm thick film/0.15 mm thick steel sheet,” and the panel composition of the resin-metal composite panel is the composition of “skin material/hard foamed urethane resin (5 mm thick)/skin material.”

The surface tension on the inner surface side of the panel skin material was measured by the measurement method based on JIS K 6768: 1999 “Plastics-Film and sheeting-Determination of wetting tension.” Further, the adhesiveness between the skin material and the hard foamed urethane resin was evaluated by measuring the peel strength of the film using an adhesive strength test. Such an adhesive strength test was performed with a test piece width: 15 mm, a tensile speed: 20 mm/min, room temperature, and a peeling direction: 180°.

The results obtained were determined based on the following determination criteria.

Good: The film peel strength is 20 N/15 mm or more

Acceptable: The film peel strength is 15 N/15 mm or more and less than 20 N/15 mm

Not acceptable: The film peel strength is less than 15 N/15 mm

As can be seen from FIG. 4, as long as the surface tension of the surface of the skin material to be bonded to the hard foamed urethane resin layer is 50 mN/m or more, the adhesiveness to the hard foamed urethane resin layer is good and the impact resistance as the resin-metal composite panel is good, which is preferable.

The inorganic hydrated oxide and inorganic oxide on the skin metal sheet is preferably one or two or more selected from the group consisting of chromium hydrated oxide and oxide, zirconium hydrated oxide and oxide, titanium hydrated oxide and oxide, tungsten hydrated oxide and oxide, cerium hydrated oxide and oxide, and silica, for example.

Further, the adhesion amount of the inorganic coating film described above is set to 1.5 mg/m² or more and 130 mg/m² or less. The case where the adhesion amount of the inorganic oxide and inorganic hydrated oxide is less than 1.5 mg/m² is not preferable because the surface of the steel sheet easily oxidizes at the stage before the laminated panel (resin-metal composite panel) is manufactured, and the adhesion to the hard foamed urethane resin decreases. On the other hand, the case where the adhesion amount of the inorganic hydrated oxide and inorganic oxide exceeds 130 mg/m² is not preferable because when bonded to the hard foamed urethane resin, the coating film containing the inorganic hydrated oxide and inorganic oxide causes a cohesive failure, peeling occurs easily, and the buckling strength of the panel decreases.

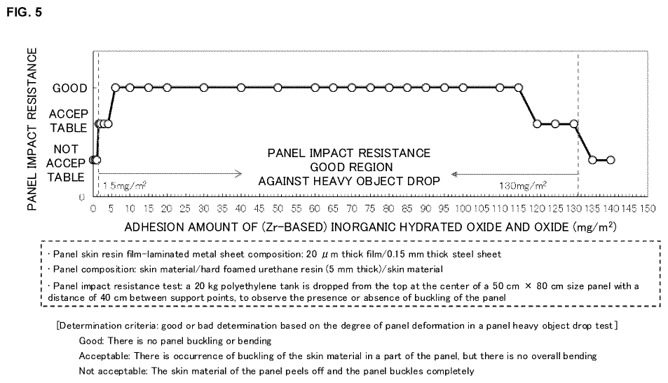

FIG. 5 is a view illustrating the relationship between an adhesion amount of zirconium (Zr)-based inorganic oxide and inorganic hydrated oxide in a resin-metal composite panel with a hard foamed urethane resin as the core resin layer, fabricated using, as the skin material, a steel sheet with a coating film of zirconium oxide and hydrated oxide formed on the surface, and impact resistance of the laminated panel. Incidentally, the above-described coating film of the zirconium oxide and hydrated oxide was fabricated in a manner that a cold-rolled steel sheet having a thickness of 0.15 mm obtained by being electrolytically degreased in a 5% aqueous sodium hydroxide solution, then immersed in 5% sulfuric acid, pickled, and washed with water was cathodically electrolyzed in zirconium fluoride. The hard foamed urethane resin used had a density of 0.3 g/cm³ and a thickness of 5 mm. Further, the size of the fabricated resin-metal composite panel was 40 cm×80 cm.

Incidentally, the vertical axis in FIG. 5 indicates an evaluation result of the impact resistance of the panel, and the horizontal axis in FIG. 5 indicates an adhesion amount of the (Zr-based) inorganic hydrated oxide and oxide (unit: mg/m²).

Here, the composition of the resin-laminated metal sheet used in evaluating the above-described impact resistance is the composition of “20 μm thick film/0.15 mm thick steel sheet”, and the panel composition of the resin-metal composite panel is the composition of “skin material/hard foamed urethane resin (5 mm thick)/skin material”.

Further, the impact resistance was evaluated by performing a panel impact resistance test. In the panel impact resistance test, a 20 kg polyethylene tank was dropped from the top at the center of a 50 cm×80 cm size panel with a distance of 40 cm between support points, and the presence or absence of buckling of the panel was observed.

The results obtained were determined based on the following determination criteria.

Good: There is no panel buckling or bending

Acceptable: There is occurrence of buckling of the skin material in a part of the panel, but there is no overall bending Not acceptable: The skin material of the panel peels off and the panel buckles completely

As can be seen from FIG. 5, the case where the adhesion amount of the inorganic hydrated oxide and oxide is less than 1.5 mg/m² or greater than 130 mg/m² is not preferable because the impact resistance of the panel decreases.

As above, the coating film containing the inorganic hydrated oxide and inorganic oxide has been explained in detail.

Incidentally, in order to further improve the adhesion of the coating film containing the inorganic hydrated oxide and inorganic oxide, a metal plating layer using the same type of metal as the counter cation of the inorganic hydrated oxide and inorganic oxide may be further provided under the coating film containing the inorganic hydrated oxide and inorganic oxide.

### <Core Resin Layer>

Next, there is described the hard foamed urethane resin forming the core resin layer of the resin-metal composite panel according to this embodiment.

The thickness of the hard foamed urethane resin functioning as the core resin layer according to this embodiment is set to 3 mm or more. The case where the thickness of the hard foamed urethane resin is less than 3 mm is not preferable because low rigidity of the panel results in low load capacity of the panel, and the panel may buckle when subjected to a dropping impact of a heavy object (about 20 kg).

Further, the hard foamed urethane resin has a dynamic longitudinal elastic modulus (to be sometimes abbreviated as “dynamic elastic modulus” below) of 100 MPa or more at 80° C. and 1 Hz, which is measured by a forced vibration type viscoelasticity measuring device. The case where the dynamic longitudinal elastic modulus of the hard foamed urethane resin at 80° C. measured at 1 Hz is less than 100 MPa is not preferable because the panel is sometimes bent if a heavy object is left on the panel such as in summer when the temperature of the panel rises. On the other hand, the dynamic longitudinal elastic modulus at 80° C. and 1 Hz, which is measured by the forced vibration type viscoelasticity measuring device, is preferably 5000 MPa or less. The case where the dynamic longitudinal elastic modulus of the hard foamed urethane resin at 80° C. measured at 1 Hz is 5000 MPa or less is preferable because it becomes possible to prevent a decrease in the impact resistance of the panel against heavy objects, even when the temperature is low, such as in winter.

Regarding the bending resistance of the resin-metal composite panel in a high-temperature environment in summer, the bending rigidity of the panel at room temperature and the bending rigidity of the panel at 80° C. were measured, and then the bending resistance was evaluated by the ratio of the bending rigidity of the panel at 80° C. to the bending rigidity of the panel at room temperature.

More specifically, the composition of the resin-laminated metal sheet was set to the composition of “20 μm thick film/0.15 mm thick steel sheet,” and the panel composition of the resin-metal composite panel was set to the composition of “skin material/hard foamed urethane resin (3 mm thickness)/skin material.”

A test piece having a size of 50 mm×200 mm was collected from the panel, and with a distance between support points: 100 mm, a semi-cylindrical punch with a punch tip diameter of 25 mm was used to perform a bending rigidity test (more specifically, a three-point bending test) at experimental temperature, room temperature, and 80° C.

Regarding the bending rigidity found from the slope of an elastic deformation region in a stroke-load diagram obtained from such a test, the ratio of the bending rigidity at 80° C. to the bending rigidity at room temperature was calculated and compared.

More specifically, in the bending rigidity test, of a resin-metal composite panel test piece having a size of 50 mm wide and 200 mm long cut with a high-speed precision cutter, a center portion between support points with a distance of 100 mm between the support points was pressed toward the compression side with a semi-cylindrical punch with a punch tip diameter of 25 mm at a punch stroke speed of 50 mm/min while using a tensile tester equipped with a thermostatic chamber. The bending rigidity was measured by finding the slope of a straight line portion in the elastic deformation region of the stroke-load diagram obtained. The test was performed by setting the temperature in the thermostatic chamber to room temperature and 80° C., the test piece was set on a three-point bending test jig, and the test was performed 10 minutes after the temperature of the thermostatic chamber reached a predetermined temperature.

The determination criteria regarding the bending rigidity are as follows.

Good: The bending rigidity of the panel at 80° C. is 80% or more of the bending rigidity at room temperature

Acceptable: The bending rigidity of the panel at 80° C. is 50% or more and less than 80% of the bending rigidity at room temperature

Not acceptable: The bending rigidity of the panel at 80° C. is less than 50% of the bending rigidity at room temperature

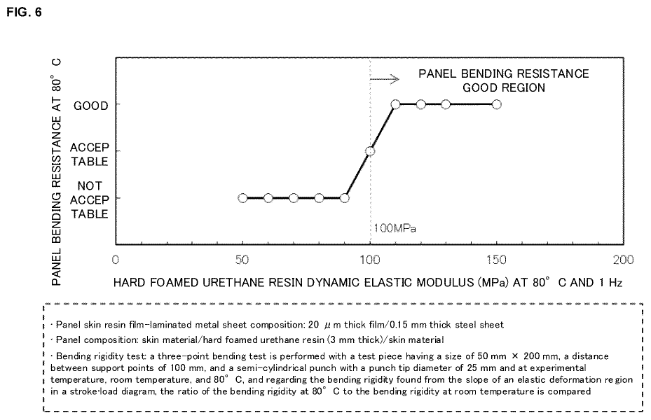

The results obtained are illustrated in FIG. 6. The vertical axis of a graph chart illustrated in FIG. 6 indicates a determination result of the bending resistance of the panel at 80° C., and the horizontal axis of the graph chart illustrated in FIG. 6 indicates a dynamic elastic modulus (unit: MPa) of the hard foamed urethane resin at 80° C. and 1 Hz.

As can be seen from FIG. 6, the case where the dynamic elastic modulus at 80° C. and 1 Hz is less than 100 MPa is not preferable because in a high-temperature environment of 80° C., the bending rigidity of the resin-metal composite panel is less than 50% of that at room temperature, failing to ensure sufficient panel rigidity.

Next, regarding the thickness of the hard foamed urethane resin layer of the resin-metal composite panel, the thickness of the hard foamed urethane resin is set to 3 mm or more as above when the resin density of the urethane resin layer is 0.2 g/cm³ or more. The case where the thickness of the hard foamed urethane resin layer is less than 3 mm is not preferable because the rigidity of the panel decreases, thus leading to insufficient impact resistance when a heavy object is dropped.

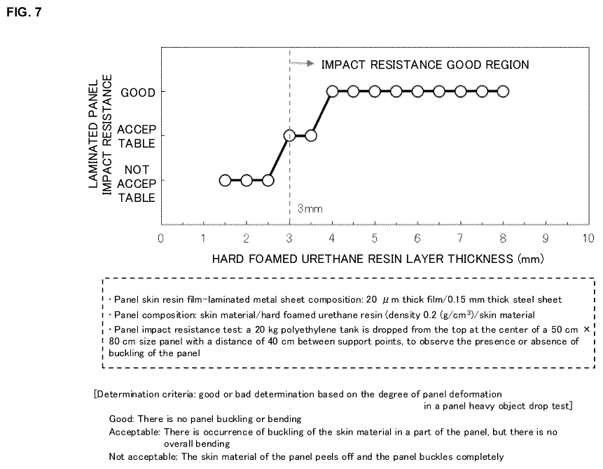

FIG. 7 illustrates the relationship between a thickness of the hard foamed urethane resin of the resin-metal composite panel (laminated panel) and impact resistance of the panel. The vertical axis of a graph chart illustrated in FIG. 7 indicates a determination result of the impact resistance of the laminated panel, and the horizontal axis of the graph chart illustrated in FIG. 7 indicates a thickness of the hard foamed urethane resin (unit: mm).

FIG. 7 was obtained from the verification that the composition of the resin-laminated metal sheet was set to the composition of “20 μm thick film/0.15 mm thick steel sheet” and the panel composition of the resin-metal composite panel was set to the composition of “skin material/hard foamed urethane resin (density 0.2 g/cm³)/skin material.”

In such verification, the impact resistance was evaluated by performing a panel impact resistance test. In the panel impact resistance test, a 20 kg polyethylene tank was dropped from the top at the center of a 50 cm×80 cm size panel with a distance of 40 cm between support points, and the presence or absence of buckling of the panel was observed.

The results obtained were determined based on the following determination criteria.

Good: There is no panel buckling or bending

Acceptable: There is occurrence of buckling of the skin material in a part of the panel, but there is no overall bending

Not acceptable: The skin material of the panel peels off and the panel buckles completely.

As can be seen from FIG. 7, the case where the thickness of the hard foamed urethane resin is less than 3 mm is not preferable because the impact resistance of the panel is poor.

Further, the thickness of the hard foamed urethane resin is preferably 10 mm or less from the viewpoint of ensuring rigidity and impact resistance of the laminated panel.

In the resin-metal composite panel according to this embodiment, the density of the hard foamed urethane resin is 0.2 g/cm³ or more and 0.7 g/cm³ or less. The case where the density of the hard foamed urethane resin is less than 0.2 g/cm³ is not preferable because foams may become too large to weaken the strength of the core resin layer and the panel may buckle when the resin-metal composite panel is subjected to a drop impact of a heavy object.

On the other hand, the case where the density of the hard urethane resin exceeds 0.7 g/cm³ is not preferable because the distribution of foams is likely to be uneven. Further, the case where the density of the hard urethane resin exceeds 0.7 g/cm³ is not preferable because the panel weight becomes heavier and further the resin cost increases.

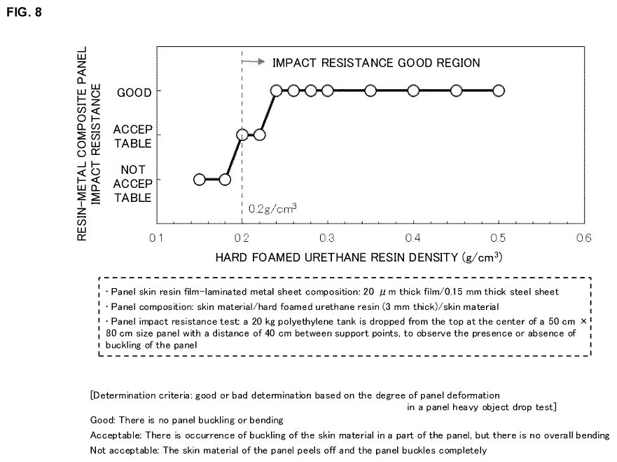

FIG. 8 illustrates the relationship between a density of the hard foamed urethane resin of the resin-metal composite panel including the hard foamed urethane resin layer having a thickness of 3 mm and impact resistance of the resin-metal composite panel. The vertical axis of a graph chart illustrated in FIG. 8 indicates a determination result of the impact resistance of the resin-metal composite panel, and the horizontal axis of the graph chart illustrated in FIG. 8 indicates a density of the hard foamed urethane resin (unit: g/cm³).

FIG. 8 was obtained from the verification that the composition of the resin-laminated metal sheet was set to the composition of “20 μm thick film/0.15 mm thick steel sheet” and the panel composition of the resin-metal composite panel was set to the composition of “skin material/hard foamed urethane resin (3 mm in thickness)/skin material.”

In such verification, the impact resistance was evaluated by performing a panel impact resistance test. In the panel impact resistance test, a 20 kg polyethylene tank was dropped from the top at the center of a 50 cm×80 cm size panel with a distance of 40 cm between support points, and the presence or absence of buckling of the panel was observed.

The results obtained were determined based on the following determination criteria.

Good: There is no panel buckling or bending

Acceptable: There is occurrence of buckling of the skin material in a part of the panel, but there is no overall bending

Not acceptable: The skin material of the panel peels off and the panel buckles completely.

As can be seen from FIG. 8, the case where the density of the hard foamed urethane resin is less than 0.2 g/cm³ is not preferable because the impact resistance of the resin-metal composite panel is poor when a heavy object is dropped.

Besides, the ratio between the total thickness of the skin material of the resin-metal composite panel and the thickness of the hard foamed urethane resin is not particularly limited. However, even if the panel skin thickness of the resin-metal composite panel is increased, the contribution ratio to the rigidity of the overall panel does not change very much, and thus, the thickness ratio of the hard foamed urethane resin of the resin-metal composite panel to the total thickness of the skin metal sheet (the thickness of the hard foamed urethane resin/the total thickness of the skin metal sheet) is preferably set to 8 or more. Further, even if the hard foamed urethane resin is made too thick relative to the total thickness of the skin metal sheet, the weight increases beyond the required rigidity. Therefore, the maximum value of the thickness ratio of the hard foamed urethane resin of the resin-metal composite panel to the total thickness of the skin metal sheet (the thickness of the hard foamed urethane resin/the total thickness of the skin metal sheet) is preferably set to 35 or less.

### <<Regarding a Manufacturing Method of the Resin-Metal Composite Panel>>

Next, there is described a manufacturing method of the resin-metal composite panel according to this embodiment.

The resin-metal composite panel according to this embodiment can be fabricated by fixing the metal sheets, which are the skin material, to an upper surface of an upper mold and a lower surface of a lower mold of a dedicated mold by suction or other means in advance, closing the upper and lower molds, and then injecting a foamable resin liquid between the upper and lower molds.

The resin to be injected between the skin metal sheets placed on the upper and lower surfaces inside the mold is set to a hard foamed urethane resin due to its ease of resin filling, a short time until foaming and curing are completed, high strength and rigidity of the core layer after completion of curing, or other reasons.

Regarding the hard foamed urethane resin, polyisocyanate, polyol, a catalyst (amine compound), a foaming agent (water or fluorocarbon), a foam stabilizer (silicone), and so on are mixed immediately before injection, and then the mixture is quickly injected to fill a space between the two skin materials. A longer time to injection after mixing a raw material liquid is not preferable because the liquid begins to cure⋅foam, the viscosity of the liquid increases rapidly, the resin may be prevented from being distributed evenly throughout the panel, and the size of foams may increase in a portion with reduced fluidity within the panel.

### <<Regarding Various Test Methods>>

There are described test methods specifically below.

### [Surface Tension Measurement]

The measurement of the surface tension on the inner surface side of the metal sheet used as the skin material of the resin-metal composite panel to be bonded to the core resin layer was performed by JIS K 6768: 1999 “Plastics-Film and sheeting-Determination of wetting tension.” In this case, the surface tension was determined from the wettability of a wetting tension test mixture (manufactured by FUJIFILM Wako Pure Chemical Corporation).

### [Resin Film-Laminated Metal Sheet Fabrication]

A film-laminated metal sheet having a size of 240 mm×300 mm was fabricated by thermally fusion-bonding a thermoplastic non-stretched film to a steel sheet heated to 300° C. by hot pressing and to one side surface of an aluminum sheet using a Teflon (registered trademark) rubber roll at a linear pressure of 100 N/cm. A sample sheet having a size of 200 mm×200 mm was cut and collected from the vicinity of the center of the obtained film-laminated metal sheet.

### [Laminated Panel Fabrication]

The fabricated resin film-laminated metal sheets having a size of 200×200 mm were attached by suction to upper and lower molds of a panel manufacturing mold provided with an upper mold and a lower mold each having a metal sheet suction hole so that the film surfaces of the resin film-laminated metal sheets were brought into contact with mold surfaces. Thereafter, the upper and lower molds were closed, and a resin mixed in a mixing tank was injected through a resin injection opening provided in the mold.

### [Resin Film-Laminated Metal Sheet Peel Strength Measurement]

The fabricated resin-metal laminated panel was cut with a high-speed precision cutting machine (HEIWA TECHNICA CO., LTD. FINE CUT) to obtain a test piece having a size of 25 mm wide×150 mm long. The resin film-laminated metal sheets on both surfaces of the end of the test piece were peeled off for about 30 mm to create grip parts for chucks of a tensile tester.

The grip parts of the resin film-laminated metal sheets on both surfaces of the test piece were pinched with the chucks of the tensile tester to peel off the resin film-laminated metal sheets for 100 mm at a tensile speed of 20 mm/min (movement distance between the chucks of 200 mm), and the peel strength between the resin film-laminated metal sheet and the foamed hard urethane resin of the core layer was measured.

A peel strength of 10 N/25 mm or more was determined to be good, a peel strength of 5 N/25 mm or more and less than 10 N/25 mm was determined to be acceptable, and a peel strength of less than 5 N/25 mm was determined to be not acceptable. Incidentally, the result of the peel strength of 5 N/25 mm or more corresponds to the minimum peel strength required to prevent the panel skin material and the core resin layer from peeling off when a 20 kg polyethylene tank is dropped from a height of 30 cm from the top of the panel.

### [Laminated Panel Impact Resistance Test]

In an impact resistance test, a test piece having a size of 50 mm×200 mm was cut and collected from the resin-metal laminated panel using a high-speed precision cutting machine. The obtained test piece was set in a DuPont impact tester equipped with a die including a roll-shaped support part with a distance between support points of 100 mm and a radius of 2.5 mm at the tip of the support part, and a semi-cylindrical punch with a radius of 5 mm as an impact indenter, and a 1 kg weight was dropped from a height of 60 mm from an impact receiving surface on top of the impact indenter. In this case, the impact resistance was determined to be good or bad by whether the test piece did not buckle or buckled.

### [Laminated Panel Dent Resistance Test]

A sample having a size of 5 cm×5 cm was cut and collected from the resin-metal laminated panel using a high-speed precision cutting machine. A dent impact was applied to the center of the obtained laminated panel sample using a DuPont impact tester (punch tip diameter=12.5 mm, falling weight condition=300 g×40 mm high), and whether the dent resistance was good or bad was determined by the degree of deformation of the sample.

### [Laminated Panel High-Temperature (80° C.) Panel Bending Resistance Evaluation Test/Panel Three-Point Bending Test]

The evaluation of the bending resistance of the panel was performed by measuring the bending rigidity of the panel in a stroke-load diagram in a three-point bending test.

The bending rigidity test was performed by pressing, of a resin-metal composite panel test piece having a size of 50 mm wide and 200 mm long cut with a high-speed precision cutter, the center portion between support points with a distance of 100 mm between the support points toward the compression side with a semi-cylindrical punch with a punch tip diameter of 25 mm at a punch stroke speed of 50 mm/min while using a tensile tester equipped with a thermostatic chamber. The bending rigidity was measured by finding the slope of a straight line portion in the elastic deformation region of the stroke-load diagram during pressing. The test was performed by setting the temperature in the thermostatic chamber to room temperature and 80° C., the test piece was set on a three-point bending test jig, and the test was performed 10 minutes after the temperature of the thermostatic chamber reached a predetermined temperature.

In the evaluation of the bending resistance of the panel at high temperature (80° C.), the case where the bending rigidity of the panel at 80° C. is 80% or more of the bending rigidity at room temperature was determined to be good, the case where the bending rigidity of the panel at 80° C. is 50% or more and less than 80% of the bending rigidity at room temperature was determined to be acceptable, and the case where the bending rigidity of the panel at 80° C. is less than 50% of the bending rigidity at room temperature was determined to be not acceptable.

### [Dynamic Viscoelasticity Test]

The measurement of the dynamic elastic modulus of the hard foamed urethane resin at 80° C. and 1 Hz was performed using a forced stretching vibration type viscoelasticity measuring device (DMA7100 manufactured by Hitachi High-Tech Corporation). The sample was prepared by cutting and collecting a sample having a thickness of 2 mm, a width of 10 mm, and a length of 40 mm from the hard foamed urethane resin with a density of 0.5 g/cm³ using a cutter knife. The measurement of the dynamic elastic modulus was performed in a measurement temperature range of 0° C. to 120° C. at a frequency of 1 Hz, a strain of 0.05%, and a temperature increase rate of 3° C./min by attaching the sample to chucks of the device with a distance between the chucks of 20 mm, and the dynamic elastic modulus at 25° C. and the dynamic elastic modulus at 80° C. were read from the graph of frequency-dynamic elastic modulus obtained, and they were set as the dynamic elastic moduli at room temperature and 80° C.

### <<Summary>>

This embodiment as explained above relates to a resin-metal composite panel formed by injecting and foaming a hard urethane resin between skin materials made of two metal sheets. The skin material is a single-sided film-laminated steel sheet having a sheet thickness of 0.1 mm or more, or a single-sided film-laminated aluminum sheet having a sheet thickness of 0.24 mm or more that includes: a thermoplastic resin layer having a film thickness of 8 μm or more and 150 μm or less on the outer surface side of the panel; and a layer having a surface tension of 50 mN/m or more that is measured by JIS K 6768: 1999 “Plastics-Film and sheeting-Determination of wetting tension” and made of inorganic hydrated oxide and inorganic oxide with an adhesion amount of 1.5 mg/m² or more and 130 mg/m² or less on the inner surface side to be bonded to a core resin layer. The hard foamed urethane resin in the core resin layer has a thickness of 3 mm or more, a dynamic longitudinal elastic modulus measured at 80° C. and 1 Hz of 100 MPa or more, and a density of the hard foamed urethane resin after foaming of 0.2 g/cm³ or more and 0.7 g/cm³ or less.

The resin-metal laminated panel having the above-described composition makes it possible to provide a laminated panel with high and stable adhesive strength between the skin metal sheet and the core layer of the resin-metal laminated panel, rigidity, and buckling strength inexpensively.

### EXAMPLE

The resin-metal laminated panel of the present invention is specifically explained with reference to examples.

The conditions in the examples, however, are only one condition employed to confirm the feasibility and effectiveness of the present invention, and the present invention is not limited to the examples below. As long as the object of the present invention is achieved without departing from the gist of the present invention, the present invention may be implemented with appropriate modifications within a range conformable to the spirit. Therefore, the present invention may employ various conditions, all of which are included in the technical features of the present invention.

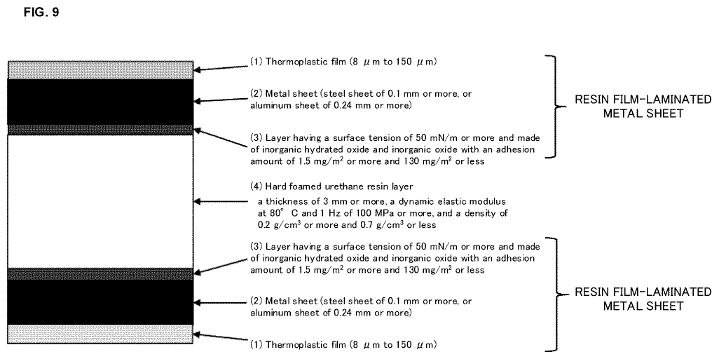

Through examples and comparative examples, we focused on a resin-metal composite panel formed by injecting and foaming a hard urethane resin between skin materials made of two metal sheets as illustrated in FIG. 9. Through the examples and comparative examples, details of a single-sided film-laminated metal sheet to be used for the skin material are illustrated in Table 1. Further, details of a thermoplastic resin film to be provided on the single-sided film-laminated metal sheet are illustrated in Table 2. Further, the composition of the urethane resin that functions as the core resin layer of the laminated panel is illustrated in Table 3. Further, the composition and property evaluation results of the laminated panel are illustrated in Table 4. Table 4 illustrates, as the determination results of the appearance and workability of the film-laminated steel sheet, determination results of the degree of film wrinkles on the film-laminated metal sheet and film cuttability during cutting, determination results of the peel strength of the resin film-laminated metal sheet of the laminated panel, determination results of the impact resistance of the laminated panel, determination results of the dent resistance of the laminated panel, and results of the high-temperature (80° C.) panel bending resistance evaluation test, along with the classification of invention examples and comparative examples.

TABLE 1

| | METAL | THICKNESS | CONVERSION TREATMENT COATING FILM | |
|---|---|---|---|---|
| SYMBOL | SHEET | (mm) | TREATMENT CONTENTS | COATING FILM KIND |
| M1 | COLD-ROLLED | 0.10 | DICHROMIC ACID IMMERSION | CHROMIUM OXIDE AND |
| | STEEL SHEET | | TREATMENT | HYDRATED OXIDE |
| M2 | COLD-ROLLED | 0.10 | DICHROMIC ACID IMMERSION | CHROMIUM OXIDE AND |
| | STEEL SHEET | | TREATMENT | HYDRATED OXIDE |
| M3 | COLD-ROLLED | 0.10 | DICHROMIC ACID IMMERSION | CHROMIUM OXIDE AND |
| | STEEL SHEET | | TREATMENT | HYDRATED OXIDE |
| M4 | COLD-ROLLED | 0.10 | DICHROMIC ACID IMMERSION | CHROMIUM OXIDE AND |
| | STEEL SHEET | | TREATMENT | HYDRATED OXIDE |
| M5 | COLD-ROLLED | 0.09 | DICHROMIC ACID IMMERSION | CHROMIUM OXIDE AND |
| | STEEL SHEET | | TREATMENT | HYDRATED OXIDE |
| M6 | COLD-ROLLED | 0.10 | CHROMIC ANHYDRIDE CATHODE | METALLIC CHROMIUM |
| | STEEL SHEET | | ELECTROLYTIC TREATMENT | CHROMIUM OXIDE AND |
| | | | | HYDRATED OXIDE |
| M7 | COLD-ROLLED | 0.10 | CHROMIC ANHYDRIDE CATHODE | METALLIC CHROMIUM |
| | STEEL SHEET | | ELECTROLYTIC TREATMENT | CHROMIUM OXIDE AND |
| | | | | HYDRATED OXIDE |
| M8 | COLD-ROLLED | 0.15 | Zr FLUORIDE, NITRIC ACID- | Zr OXIDE AND |
| | STEEL SHEET | | BASED TREATMENT SOLUTION | Zr HYDRATED OXIDE |
| | | | CATHODE ELECTROLYTIC | |
| | | | TREATMENT | |
| M9 | COLD-ROLLED | 0.15 | Zr FLUORIDE, NITRIC ACID- | Zr OXIDE AND |
| | STEEL SHEET | | BASED TREATMENT SOLUTION | Zr HYDRATED OXIDE |
| | | | CATHODE ELECTROLYTIC | |
| | | | TREATMENT | |
| M10 | COLD-ROLLED | 0.15 | Zr FLUORIDE, NITRIC ACID- | Zr OXIDE AND |
| | STEEL SHEET | | BASED TREATMENT SOLUTION | Zr HYDRATED OXIDE |
| | | | CATHODE ELECTROLYTIC | |
| | | | TREATMENT | |
| M11 | COLD-ROLLED | 0.15 | Zr FLUORIDE, NITRIC ACID- | Zr OXIDE AND |
| | STEEL SHEET | | BASED TREATMENT SOLUTION | Zr HYDRATED OXIDE |
| | | | CATHODE ELECTROLYTIC | |
| | | | TREATMENT | |
| M12 | COLD-ROLLED | 0.15 | Zr FLUORIDE, NITRIC ACID- | Zr OXIDE AND |
| | STEEL SHEET | | BASED TREATMENT SOLUTION | Zr HYDRATED OXIDE |
| | | | CATHODE ELECTROLYTIC | |
| | | | TREATMENT | |
| M13 | COLD-ROLLED | 0.15 | Zr FLUORIDE-BASED | Zr OXIDE AND |
| | STEEL SHEET | | TREATMENT SOLUTION | Zr HYDRATED OXIDE |
| | | | CATHODE ELECTROLYTIC | |
| | | | TREATMENT | |
| M14 | COLD-ROLLED | 0.15 | Ti FLUORIDE, NITRIC ACID- | Ti OXIDE AND |
| | STEEL SHEET | | BASED TREATMENT SOLUTION | Ti HYDRATED OXIDE |
| | | | CATHODE ELECTROLYTIC | |
| | | | TREATMENT | |
| M15 | COLD-ROLLED | 0.15 | Ti FLUORIDE, NITRIC ACID- | Ti OXIDE AND |
| | STEEL SHEET | | BASED TREATMENT SOLUTION | Ti HYDRATED OXIDE |
| | | | CATHODE ELECTROLYTIC | |
| | | | TREATMENT | |
| M16 | COLD-ROLLED | 0.15 | TUNGSTIC ACID IMMERSION | W OXIDE AND |
| | STEEL SHEET | | TREATMENT | W HYDRATED OXIDE |
| M17 | COLD-ROLLED | 0.15 | NITRIC ACID Ce-BASED | Ce OXIDE AND |
| | STEEL SHEET | | TREATMENT SOLUTION | Ce HYDRATED OXIDE |
| | | | CATHODE ELECTROLYTIC | |
| | | | TREATMENT | |
| M18 | COLD-ROLLED | 0.15 | NITRIC ACID Ce-BASED | Ce OXIDE AND |
| | STEEL SHEET | | TREATMENT SOLUTION | Ce HYDRATED OXIDE |
| | | | CATHODE ELECTROLYTIC | |
| | | | TREATMENT | |
| M19 | COLD-ROLLED | 0.15 | COATING SILICA | SiO₂ |
| | STEEL SHEET | | | |
| M20 | COLD-ROLLED | 0.15 | COATING SILICA | SiO₂ |
| | STEEL SHEET | | | |
| M21 | COLD-ROLLED | 0.15 | COATING SILICA | SiO₂ |
| | STEEL SHEET | | | |
| M22 | COLD-ROLLED | 0.15 | COATING SILICA | SiO₂ |
| | STEEL SHEET | | | |
| M23 | COLD-ROLLED | 0.10 | COATING TANNIC ACID | TANNIC ACID COATING |
| | STEEL SHEET | | | FILM |
| M24 | COLD-ROLLED | 0.10 | SILANE COUPLING TREATMENT | ORGANIC SILANOL |
| | STEEL SHEET | | | COATING FILM |
| M25 | SUS304 | 0.10 | DICHROMIC ACID IMMERSION | CHROMIUM OXIDE AND |
| | BRIGHT ANNEALED | | TREATMENT | HYDRATED OXIDE |
| | MATERIAL | | | |
| M26 | ALUMINUM SHEET | 0.24 | DICHROMIC ACID IMMERSION | CHROMIUM OXIDE AND |
| | A1100 | | TREATMENT | HYDRATED OXIDE |
| M27 | ALUMINUM SHEET | 0.22 | DICHROMIC ACID IMMERSION | CHROMIUM OXIDE AND |
| | A1100 | | TREATMENT | HYDRATED OXIDE |
| M28 | ALUMINUM SHEET | 0.24 | DICHROMIC ACID IMMERSION | CHROMIUM OXIDE AND |
| | A5052 | | TREATMENT | HYDRATED OXIDE |
| M29 | ALUMINUM SHEET | 0.23 | DICHROMIC ACID IMMERSION | CHROMIUM OXIDE AND |
| | A5052 | | TREATMENT | HYDRATED OXIDE |
| M30 | COLD-ROLLED | 0.20 | NONE | |
| | STEEL SHEET | | | |

| | | * SURFACE TENSION | |
|---|---|---|---|
| | | ON SIDE TO BE IN | |
| | | CONTACT WITH | |
| | CONVERSION TREATMENT COATING FILM | URETHANE CORE | WEIGHT |
| | ADHESION AMOUNT | LAYER | PER 1 m² |
| SYMBOL | (mg/m²) | (mN/m) | (kg) |
| M1 | CHROMIUM | 52 | 0.785 |
| | OXIDE•HYDRATED OXIDE: 1.5 | | |
| M2 | CHROMIUM | 48 | 0.785 |
| | OXIDE•HYDRATED OXIDE: 1.4 | | |
| M3 | CHROMIUM | 60 | 0.785 |
| | OXIDE•HYDRATED OXIDE: 130 | | |
| M4 | CHROMIUM | 60 | 0.785 |
| | OXIDE•HYDRATED OXIDE: 135 | | |
| M5 | CHROMIUM | 52 | 0.7065 |
| | OXIDE•HYDRATED OXIDE: 5 | | |
| M6 | METALLIC CHROMIUM: 100 | 54 | 0.785 |
| | CHROMIUM | | |
| | OXIDE•HYDRATED OXIDE: 10 | | |
| M7 | METALLIC CHROMIUM: 50 | 50 | 0.785 |
| | CHROMIUM | | |
| | OXIDE•HYDRATED OXIDE: 1.3 | | |
| M8 | 1.5 | 50 | 1.1775 |
| M9 | 60 | 56 | 1.1775 |
| M10 | 130 | 60 | 1.1775 |
| M11 | 1.4 | 50 | 1.1775 |
| M12 | 135 | 60 | 1.1775 |
| M13 | 2 | 48 | 1.1775 |
| M14 | 1.3 | 54 | 1.1775 |
| M15 | 1.5 | 54 | 1.1775 |
| M16 | 3 | 52 | 1.1775 |
| M17 | 1.5 | 52 | 1.1775 |
| M18 | 1.3 | 52 | 1.1775 |
| M19 | 1.3 | 54 | 1.1775 |
| M20 | 1.5 | 56 | 1.1775 |
| M21 | 130 | 60 | 1.1775 |
| M22 | 135 | 60 | 1.1775 |
| M23 | 25 | 54 | 0.785 |
| M24 | 5 | 60 | 0.785 |
| M25 | CHROMIUM | 52 | 0.793 |
| | OXIDE•HYDRATED OXIDE: 1.5 | | |
| M26 | CHROMIUM | 52 | 0.648 |
| | OXIDE•HYDRATED OXIDE: 1.5 | | |
| M27 | CHROMIUM | 52 | 0.594 |
| | OXIDE•HYDRATED OXIDE: 1.5 | | |
| M28 | CHROMIUM | 52 | 0.648 |
| | OXIDE•HYDRATED OXIDE: 1.5 | | |
| M29 | CHROMIUM | 52 | 0.621 |
| | OXIDE•HYDRATED OXIDE: 1.5 | | |
| M30 | NONE | >70 | 1.57 |

* SURFACE TENSION IS MEASURED BY JIS K 6768: 1999 “PLASTICS-FILM AND SHEETING DETERMINATION OF WETTING TENSION”

TABLE 2

| | | MELTING | | SURFACE | |
|---|---|---|---|---|---|
| | | POINT | SURFACE | ROUGHNESS | THICK- |
| SYM- | | Tm | TENSION | Ra | NESS |
| BOL | THERMOPLASTIC RESIN FILM CONTENTS | (° C.) | (mN/m) | (μm) | (μm) |
| F1 | THERMOPLASTIC STRETCHED *1 HOMO-PET FILM | 252 | 48 | 0.2 | 8 |
| F2 | THERMOPLASTIC STRETCHED *1 HOMO-PET FILM | 252 | 48 | 0.2 | 25 |
| F3 | THERMOPLASTIC STRETCHED *1 HOMO-PET FILM | 252 | 48 | 0.2 | 150 |
| F4 | THERMOPLASTIC STRETCHED *1 HOMO-PET FILM | 252 | 48 | 0.2 | 6 |
| F5 | THERMOPLASTIC STRETCHED *1 HOMO-PET FILM | 252 | 48 | 0.2 | 155 |
| F6 | THERMOPLASTIC STRETCHED *2 PET-IA FILM | 227 | 50 | 0.2 | 8 |
| F7 | THERMOPLASTIC STRETCHED *2 PET-IA FILM | 227 | 50 | 0.2 | 25 |
| F8 | THERMOPLASTIC STRETCHED *2 PET-IA FILM | 227 | 50 | 0.2 | 150 |
| F9 | THERMOPLASTIC STRETCHED *2 PET-IA FILM | 227 | 50 | 0.2 | 6 |
| F10 | THERMOPLASTIC STRETCHED *2 PET-IA FILM | 227 | 50 | 0.2 | 155 |
| F11 | THERMOPLASTIC STRETCHED *3 PET PBT FILM | 213 | 52 | 0.3 | 8 |
| F12 | THERMOPLASTIC STRETCHED *3 PET PBT FILM | 213 | 52 | 0.3 | 25 |
| F13 | THERMOPLASTIC STRETCHED *3 PET PBT FILM | 213 | 52 | 0.2 | 150 |
| F14 | THERMOPLASTIC STRETCHED *3 PET PBT FILM | 213 | 52 | 0.2 | 6 |
| F15 | THERMOPLASTIC STRETCHED *3 PET PBT FILM | 213 | 52 | 0.2 | 155 |
| F16 | POLYETHYLENE RESIN FILM WITH THERMOPLASTIC NON- | 120 | 40 | 0.2 | 8 |
| | STRETCHED *4 MODIFIED RESIN LAYER | | | | |
| F17 | POLYETHYLENE RESIN FILM WITH THERMOPLASTIC NON- | 120 | 38 | 0.2 | 50 |
| | STRETCHED *4 MODIFIED RESIN LAYER | | | | |
| F18 | POLYETHYLENE RESIN FILM WITH THERMOPLASTIC NON- | 120 | 40 | 0.2 | 150 |
| | STRETCHED *4 MODIFIED RESIN LAYER | | | | |
| F19 | POLYETHYLENE RESIN FILM WITH THERMOPLASTIC NON- | 120 | 40 | 0.2 | 6 |
| | STRETCHED *4 MODIFIED RESIN LAYER | | | | |
| F20 | POLYETHYLENE RESIN FILM WITH THERMOPLASTIC NON- | 120 | 40 | 0.2 | 155 |
| | STRETCHED *4 MODIFIED RESIN LAYER | | | | |
| F21 | ETHYLENE•PROPYLENE COPOLYMER RESIN FILMWITH | 140 | 40 | 0.2 | 8 |
| | THERMOPLASTIC NON-STRETCHED *5 MODIFIED RESIN LAYER | | | | |
| F22 | ETHYLENE•PROPYLENE COPOLYMER RESIN FILMWITH | 140 | 40 | 0.2 | 50 |
| | THERMOPLASTIC NON-STRETCHED *5 MODIFIED RESIN LAYER | | | | |
| F23 | ETHYLENE•PROPYLENE COPOLYMER RESIN FILMWITH | 140 | 38 | 0.2 | 150 |
| | THERMOPLASTIC NON-STRETCHED *5 MODIFIED RESIN LAYER | | | | |
| F24 | ETHYLENE•PROPYLENE COPOLYMER RESIN FILMWITH | 140 | 40 | 0.2 | 6 |
| | THERMOPLASTIC NON-STRETCHED *5 MODIFIED RESIN LAYER | | | | |
| F25 | ETHYLENE•PROPYLENE COPOLYMER RESIN FILMWITH | 140 | 40 | 0.2 | 155 |
| | THERMOPLASTIC NON-STRETCHED *5 MODIFIED RESIN LAYER | | | | |
| F26 | THERMOPLASTIC NON-STRETCHED IONOMER-BASED RESIN FILM | 100 | 40 | 0.3 | 25 |
| F27 | THERMOPLASTIC NON-STRETCHED VINYL CHLORIDE RESIN FILM | 170 | 44 | 0.3 | 25 |

*1 POLYETHYLENE TEREPHTHALATE RESIN FILM
*2 POLYETHYLENE TEREPHTHALATE•ISOPHTHALATE 8 MOL % COPOLYMER RESIN FILM
*3 POLYETHYLENE TEREPHTHALATE•POLYBUTYLENE TEREPHTHALATE 50 MASS % COPOLYMER RESIN FILM
*4 PHTHALIC ANHYDRIDE-MODIFIED POLYETHYLENE RESIN FILM
*5 SURFACE TO BE FUSED TO METAL SHEET IS PET (POLYETHYLENE TEREPHTHALATE) RESIN, AND OPPOSITE SURFACE IS MALEIC ANHYDRIDE-MODIFIED POLYETHYLENE

TABLE 3

| | | | | DYNAMIC | |
|---|---|---|---|---|---|
| | | | | ELASTIC | |
| | | THICK- | | MODULUS AT | WEIGHT |
| SYM- | COMPONENTS OF URETHANE CORE LAYER | NESS | DENSITY | 80° C. · 1 Hz | PER 1 m² |
| BOL | OF RESIN-METAL LAMINATED PANEL | (mm) | (g/cm²) | (MPa) | (kg) |
| C1 | TOLYLENE DIISOCYANATE (TDI), POLYETHER POLYOL, 1,4- | 3 | 0.2 | 100 | 0.6 |
| C2 | BUTANEDIOL, FOAMING AGENT (HFC), CATALYST | 5 | 0.2 | 100 | 1 |
| C3 | (TRIETHYLENEDIAMINE(2-DIMETHYLAMINOETHYL)ETHER•N,N,N′,N′,- | 15 | 0.2 | 100 | 3 |
| C4 | TETRAMETHYLHEXAMETHYLENEDIAMINE), SILICONE OIL | 5 | 0.5 | 100 | 2.5 |
| C5 | | 5 | 0.7 | 100 | 3.5 |
| C6 | | 10 | 0.22 | 100 | 2.2 |
| C7 | | 5 | 0.5 | 120 | 2.5 |
| C8 | | 2 | 0.5 | 110 | 1 |
| C9 | | 5 | 0.18 | 110 | 0.9 |
| C10 | | 5 | 0.75 | 110 | 3.75 |
| C11 | | 5 | 0.3 | 90 | 1.5 |
| C12 | DIPHENYLMETHANE DIISOCYANATE (MDI), POLYESTER POLYOL, | 5 | 0.2 | 100 | 1 |
| C13 | POLYETHYLENE POLYAMINE, FOAMING AGENT (HFC), CATALYST | 5 | 0.5 | 100 | 2.5 |
| C14 | (TRIETHYLENEDIAMINE(2-DIMETHYLAMINOETHYL)ETHER•N,N,N′,N′,- | 5 | 0.7 | 100 | 3.5 |
| C15 | TETRAMETHYLHEXAMETHYLENEDIAMINE), SILICONE OIL | 5 | 0.3 | 90 | 1.5 |
| C16 | | 5 | 0.3 | 110 | 1.5 |
| C17 | | 2 | 0.5 | 110 | 1 |
| C18 | | 5 | 0.18 | 100 | 0.9 |
| C19 | | 5 | 0.75 | 100 | 3.75 |

TABLE 4

| | RESIN-METAL LAMINATED PANEL COMPOSITION | | | | | | | |
|---|---|---|---|---|---|---|---|---|
| | SKIN MATERIAL COMPOSITION | | | | | | | |
| | AND FABRICATION CONDITION | | | | PANEL COMPONENT THICKNESS | | | |
| | | FILMTO BE | | | METAL | URETHANE | | RATIO OF |
| | | PANEL | RESIN FILM | | SHEET | RESIN | PANEL | URETHANE RESIN |
| | | OUTER | LAMINATION | URETHANE | TOTAL | LAYER | TOTAL | LAYER THICKNESS |
| | METAL | SURFACE | TEMPERATURE | CORE | THICKNESS | THICKNESS | THICKNESS | TO METAL SHEET |
| SYMBOL | SHEET | SIDE | (° C.) | LAYER | (mm) | (mm) | (mm) | TOTAL THICKNESS |
| P1 | M1 | F2 | 270 | C7 | 0.20 | 5.0 | 5.2 | 25.0 |
| P2 | M2 | F2 | 270 | C7 | 0.20 | 5.0 | 5.2 | 25.0 |
| P3 | M3 | F2 | 270 | C7 | 0.20 | 5.0 | 5.2 | 25.0 |
| P4 | M4 | F2 | 270 | C7 | 0.20 | 5.0 | 5.2 | 25.0 |
| P5 | M5 | F2 | 270 | C7 | 0.18 | 5.0 | 5.2 | 27.8 |
| P6 | M6 | F2 | 270 | C7 | 0.20 | 5.0 | 5.2 | 25.0 |
| P7 | M7 | F2 | 270 | C7 | 0.20 | 5.0 | 5.2 | 25.0 |
| P8 | M8 | F2 | 270 | C7 | 0.30 | 5.0 | 5.3 | 16.7 |
| P9 | M9 | F2 | 270 | C7 | 0.30 | 5.0 | 5.3 | 16.7 |
| P10 | M10 | F2 | 270 | C7 | 0.30 | 5.0 | 5.3 | 16.7 |
| P11 | M11 | F2 | 270 | C7 | 0.30 | 5.0 | 5.3 | 16.7 |
| P12 | M12 | F2 | 270 | C7 | 0.30 | 5.0 | 5.3 | 16.7 |
| P13 | M13 | F2 | 270 | C7 | 0.30 | 5.0 | 5.3 | 16.7 |
| P14 | M14 | F2 | 270 | C7 | 0.30 | 5.0 | 5.3 | 16.7 |
| P15 | M15 | F2 | 270 | C7 | 0.30 | 5.0 | 5.3 | 16.7 |
| P16 | M16 | F2 | 270 | C7 | 0.30 | 5.0 | 5.3 | 16.7 |
| P17 | M17 | F2 | 270 | C7 | 0.30 | 5.0 | 5.3 | 16.7 |
| P18 | M18 | F2 | 270 | C7 | 0.30 | 5.0 | 5.3 | 16.7 |
| P19 | M19 | F2 | 270 | C7 | 0.30 | 5.0 | 5.3 | 16.7 |
| P20 | M20 | F2 | 270 | C7 | 0.30 | 5.0 | 5.3 | 16.7 |
| P21 | M21 | F2 | 270 | C7 | 0.30 | 5.0 | 5.3 | 16.7 |
| P22 | M22 | F2 | 270 | C7 | 0.30 | 5.0 | 5.3 | 16.7 |
| P23 | M23 | F2 | 270 | C7 | 0.20 | 5.0 | 5.2 | 25.0 |
| P24 | M24 | F2 | 270 | C7 | 0.20 | 5.0 | 5.2 | 25.0 |
| P25 | M25 | F2 | 270 | C7 | 0.20 | 5.0 | 5.2 | 25.0 |
| P26 | M26 | F2 | 270 | C7 | 0.48 | 5.0 | 5.5 | 10.4 |
| P27 | M27 | F2 | 270 | C7 | 0.44 | 5.0 | 5.4 | 11.4 |
| P28 | M28 | F2 | 270 | C7 | 0.48 | 5.0 | 5.5 | 10.4 |
| P29 | M29 | F2 | 270 | C7 | 0.46 | 5.0 | 5.5 | 10.9 |
| P30 | M30 | F2 | 270 | C7 | 0.40 | 5.0 | 5.4 | 12.5 |
| P31 | M9 | F1 | 270 | C7 | 0.30 | 5.0 | 5.3 | 16.7 |
| P32 | M9 | F3 | 270 | C7 | 0.30 | 5.0 | 5.3 | 16.7 |
| P33 | M9 | F4 | 270 | C7 | 0.30 | 5.0 | 5.3 | 16.7 |
| P34 | M9 | F5 | 270 | C7 | 0.30 | 5.0 | 5.3 | 16.7 |
| P35 | MS | F6 | 245 | C7 | 0.30 | 5.0 | 5.3 | 16.7 |
| P36 | MS | F7 | 245 | C7 | 0.30 | 5.0 | 5.3 | 16.7 |
| P37 | MS | F8 | 245 | C7 | 0.30 | 5.0 | 5.3 | 16.7 |
| P38 | M9 | F9 | 245 | C7 | 0.30 | 5.0 | 5.3 | 16.7 |
| P39 | M9 | F10 | 245 | C7 | 0.30 | 5.0 | 5.3 | 16.7 |
| P40 | M9 | F11 | 230 | C7 | 0.30 | 5.0 | 5.3 | 16.7 |
| P41 | M9 | F12 | 230 | C7 | 0.30 | 5.0 | 5.3 | 16.7 |
| P42 | MS | F13 | 230 | C7 | 0.30 | 5.0 | 5.3 | 16.7 |
| P43 | M9 | F14 | 230 | C7 | 0.30 | 5.0 | 5.3 | 16.7 |
| P44 | M9 | F15 | 230 | C7 | 0.30 | 5.0 | 5.3 | 16.7 |
| P45 | M9 | F16 | 140 | C7 | 0.30 | 5.0 | 5.3 | 16.7 |
| P46 | M9 | F17 | 140 | C7 | 0.30 | 5.0 | 5.3 | 16.7 |
| P47 | M9 | F18 | 140 | C7 | 0.30 | 5.0 | 5.3 | 16.7 |
| P48 | M9 | F19 | 140 | C7 | 0.30 | 5.0 | 5.3 | 16.7 |
| P49 | M9 | F20 | 140 | C7 | 0.30 | 5.0 | 5.3 | 16.7 |
| P50 | M9 | F21 | 160 | C7 | 0.30 | 5.0 | 5.3 | 16.7 |
| P51 | M9 | F22 | 160 | C7 | 0.30 | 5.0 | 5.3 | 16.7 |
| P52 | M9 | F23 | 160 | C7 | 0.30 | 5.0 | 5.3 | 16.7 |
| P53 | M9 | F24 | 160 | C7 | 0.30 | 5.0 | 5.3 | 16.7 |
| P54 | M9 | F25 | 160 | C7 | 0.30 | 5.0 | 5.3 | 16.7 |
| P55 | M9 | F26 | 140 | C7 | 0.30 | 5.0 | 5.3 | 16.7 |
| P56 | M9 | F27 | 200 | C7 | 0.30 | 5.0 | 5.3 | 16.7 |
| P57 | M9 | F2 | 270 | C1 | 0.30 | 3.0 | 3.3 | 10.0 |
| P58 | MS | F2 | 270 | C2 | 0.30 | 5.0 | 5.3 | 16.7 |
| P59 | M9 | F2 | 270 | C3 | 0.30 | 15.0 | 15.3 | 50.0 |
| P60 | M9 | F2 | 270 | C4 | 0.30 | 5.0 | 5.3 | 16.7 |
| P61 | M9 | F2 | 270 | C5 | 0.30 | 5.0 | 5.3 | 16.7 |
| P62 | M9 | F2 | 270 | C6 | 0.30 | 10.0 | 10.3 | 33.3 |
| P63 | M9 | F2 | 270 | C8 | 0.30 | 2.0 | 2.3 | 6.7 |
| P64 | M9 | F2 | 270 | C9 | 0.30 | 5.0 | 5.3 | 16.7 |
| P65 | M9 | F2 | 270 | C10 | 0.30 | 5.0 | 5.3 | 16.7 |
| P66 | M9 | F2 | 270 | C11 | 0.30 | 5.0 | 5.3 | 16.7 |
| P67 | M9 | F2 | 270 | C12 | 0.30 | 5.0 | 5.3 | 16.7 |
| P68 | M9 | F2 | 270 | C13 | 0.30 | 5.0 | 5.3 | 16.7 |
| P69 | M9 | F2 | 270 | C14 | 0.30 | 5.0 | 5.3 | 16.7 |
| P70 | M9 | F2 | 270 | C15 | 0.30 | 5.0 | 5.3 | 16.7 |
| P71 | M9 | F2 | 270 | C16 | 0.30 | 5.0 | 5.3 | 16.7 |
| P72 | M9 | F2 | 270 | C17 | 0.30 | 2.0 | 2.3 | 6.7 |
| P73 | M9 | F2 | 270 | C18 | 0.30 | 5.0 | 5.3 | 16.7 |
| P74 | M9 | F2 | 270 | C19 | 0.30 | 5.0 | 5.3 | 16.7 |

| | | | | DETERMINATION RESULTS OF REIN-METAL LAMINATED | |
|---|---|---|---|---|---|
| | RESIN-METAL LAMINATED PANEL COMPOSITION | | | PANEL PROPERTIES | |
| | PANEL COMPONENT WEIGHT | | | FILM-LAMINATED STEEL SHEET APPEARANCE AND | |
| | METAL SHEET | URETHANE RESIN | | WORKABILITY DETERMINATION RESULT | |
| | WEIGHT | LAYER WEIGHT | | *1 FILM WRINKLE | *2 DETERMINATION |
| | PER 1 m² | PER 1 m² | PANEL WEIGHT | DEGREE DETERMINATION | RESULT OF FILM |
| | OF PANEL | OF PANEL | PER 1 m² | RESULT OF FILM- | CUTTABILITY |
| SYMBOL | (kg) | (kg) | (kg) | LAMINATED METAL SHEET | DURING CUTTING |
| P1 | 1.57 | 2.50 | 4.07 | GOOD | GOOD |
| P2 | 1.57 | 2.50 | 4.07 | GOOD | GOOD |
| P3 | 1.57 | 2.50 | 4.07 | GOOD | GOOD |
| P4 | 1.57 | 2.50 | 4.07 | GOOD | GOOD |
| P5 | 1.41 | 2.50 | 3.91 | GOOD | GOOD |
| P6 | 1.57 | 2.50 | 4.07 | GOOD | GOOD |
| P7 | 1.57 | 2.50 | 4.07 | GOOD | GOOD |
| P8 | 2.36 | 2.50 | 4.86 | GOOD | GOOD |
| P9 | 2.36 | 2.50 | 4.86 | GOOD | GOOD |
| P10 | 2.36 | 2.50 | 4.86 | GOOD | GOOD |
| P11 | 2.36 | 2.50 | 4.86 | GOOD | GOOD |
| P12 | 2.36 | 2.50 | 4.86 | GOOD | GOOD |
| P13 | 2.36 | 2.50 | 4.86 | GOOD | GOOD |
| P14 | 2.36 | 2.50 | 4.86 | GOOD | GOOD |
| P15 | 2.36 | 2.50 | 4.86 | GOOD | GOOD |
| P16 | 2.36 | 2.50 | 4.86 | GOOD | GOOD |
| P17 | 2.36 | 2.50 | 4.86 | GOOD | GOOD |
| P18 | 2.36 | 2.50 | 4.86 | GOOD | GOOD |
| P19 | 2.36 | 2.50 | 4.86 | GOOD | GOOD |
| P20 | 2.36 | 2.50 | 4.86 | GOOD | GOOD |
| P21 | 2.36 | 2.50 | 4.86 | GOOD | GOOD |
| P22 | 2.36 | 2.50 | 4.86 | GOOD | GOOD |
| P23 | 1.57 | 2.50 | 4.07 | GOOD | GOOD |
| P24 | 1.57 | 2.50 | 4.07 | GOOD | GOOD |
| P25 | 1.59 | 2.50 | 4.09 | GOOD | GOOD |
| P26 | 1.30 | 2.50 | 3.80 | GOOD | GOOD |
| P27 | 1.19 | 2.50 | 3.69 | GOOD | GOOD |
| P28 | 1.30 | 2.50 | 3.80 | GOOD | GOOD |
| P29 | 1.24 | 2.50 | 3.74 | GOOD | GOOD |
| P30 | 3.14 | 2.50 | 5.64 | GOOD | GOOD |
| P31 | 2.36 | 2.50 | 4.86 | ACCEPTABLE | GOOD |
| P32 | 2.36 | 2.50 | 4.86 | GOOD | ACCEPTABLE |
| P33 | 2.36 | 2.50 | 4.86 | NOT | GOOD |
| | | | | ACCEPTABLE | |
| P34 | 2.36 | 2.50 | 4.86 | GOOD | NOT |
| | | | | | ACCEPTABLE |
| P35 | 2.36 | 2.50 | 4.86 | ACCEPTABLE | GOOD |
| P36 | 2.36 | 2.50 | 4.86 | GOOD | GOOD |
| P37 | 2.36 | 2.50 | 4.86 | GOOD | ACCEPTABLE |
| P38 | 2.36 | 2.50 | 4.86 | NOT | GOOD |
| | | | | ACCEPTABLE | |
| P39 | 2.36 | 2.50 | 4.86 | GOOD | NOT |
| | | | | | ACCEPTABLE |
| P40 | 2.36 | 2.50 | 4.86 | ACCEPTABLE | GOOD |
| P41 | 2.36 | 2.50 | 4.86 | GOOD | GOOD |
| P42 | 2.36 | 2.50 | 4.86 | GOOD | ACCEPTABLE |
| P43 | 2.36 | 2.50 | 4.86 | NOT | GOOD |
| | | | | ACCEPTABLE | |
| P44 | 2.36 | 2.50 | 4.86 | GOOD | NOT |
| | | | | | ACCEPTABLE |
| P45 | 2.36 | 2.50 | 4.86 | ACCEPTABLE | GOOD |
| P46 | 2.36 | 2.50 | 4.86 | ACCEPTABLE | ACCEPTABLE |
| P47 | 2.36 | 2.50 | 4.86 | GOOD | ACCEPTABLE |
| P48 | 2.36 | 2.50 | 4.86 | NOT | GOOD |
| | | | | ACCEPTABLE | |
| P49 | 2.36 | 2.50 | 4.86 | GOOD | NOT |
| | | | | | ACCEPTABLE |
| P50 | 2.36 | 2.50 | 4.86 | ACCEPTABLE | GOOD |
| P51 | 2.36 | 2.50 | 4.86 | GOOD | ACCEPTABLE |
| P52 | 2.36 | 2.50 | 4.86 | ACCEPTABLE | ACCEPTABLE |
| P53 | 2.36 | 2.50 | 4.86 | NOT | GOOD |
| | | | | ACCEPTABLE | |
| P54 | 2.36 | 2.50 | 4.86 | GOOD | NOT |
| | | | | | ACCEPTABLE |
| P55 | 2.36 | 2.50 | 4.86 | GOOD | GOOD |
| P56 | 2.36 | 2.50 | 4.86 | GOOD | GOOD |
| P57 | 2.36 | 0.60 | 2.96 | GOOD | GOOD |
| P58 | 2.36 | 1.00 | 3.36 | GOOD | GOOD |
| P59 | 2.36 | 3.00 | 5.36 | GOOD | GOOD |
| P60 | 2.36 | 2.50 | 4.86 | GOOD | GOOD |
| P61 | 2.36 | 3.50 | 5.86 | GOOD | GOOD |
| P62 | 2.36 | 2.20 | 4.56 | GOOD | GOOD |
| P63 | 2.36 | 1.00 | 3.36 | GOOD | GOOD |
| P64 | 2.36 | 0.90 | 3.26 | GOOD | GOOD |
| P65 | 2.36 | 3.75 | 6.11 | GOOD | GOOD |
| P66 | 2.36 | 1.50 | 3.86 | GOOD | GOOD |
| P67 | 2.36 | 1.00 | 3.36 | GOOD | GOOD |
| P68 | 2.36 | 2.50 | 4.86 | GOOD | GOOD |
| P69 | 2.36 | 3.50 | 5.86 | GOOD | GOOD |
| P70 | 2.36 | 1.50 | 3.86 | GOOD | GOOD |
| P71 | 2.36 | 1.50 | 3.86 | GOOD | GOOD |
| P72 | 2.36 | 1.00 | 3.36 | GOOD | GOOD |
| P73 | 2.36 | 0.90 | 3.26 | GOOD | GOOD |
| P74 | 2.36 | 3.75 | 6.11 | GOOD | GOOD |

| | DETERMINATION RESULTS OF REIN-METAL LAMINATED PANEL PROPERTIES | | | | |
|---|---|---|---|---|---|
| | | | | *6 PANEL BENDING | |
| | *3 PEEL STRENGTH | *4 IMPACT | *5 DENT | RESISTANCE EVALUATION | |
| | DETERMINATION | RESISTANCE | RESISTANCE | TEST RESULT OF | INVENTION |
| | RESULT OF RESIN | DETERMINATION | DETERMINATION | LAMINATED PANEL AT | EXAMPLE AND |
| | FILM-LAMINATED | RESULT OF | RESULT OF | HIGH-TEMPERATURE (80° C.)/ | COMPARATIVE |
| | METAL SHEET ON | LAMINATED | LAMINATED | PANEL THREE-POINT | EXAMPLE |
| SYMBOL | LAMINATED PANEL | PANEL | PANEL | BENDING TEST | CLASSIFICATION |
| P1 | ACCEPTABLE | GOOD | ACCEPTABLE | GOOD | INVENTION |
| | | | | | EXAMPLE |
| P2 | NOT | ACCEPTABLE | ACCEPTABLE | GOOD | COMPARATIVE |
| | ACCEPTABLE | | | | EXAMPLE |
| P3 | GOOD | GOOD | ACCEPTABLE | GOOD | INVENTION |
| | | | | | EXAMPLE |
| P4 | GOOD | NOT | ACCEPTABLE | GOOD | COMPARATIVE |
| | | ACCEPTABLE | | | EXAMPLE |
| P5 | ACCEPTABLE | ACCEPTABLE | NOT | GOOD | COMPARATIVE |
| | | | ACCEPTABLE | | EXAMPLE |
| P6 | ACCEPTABLE | GOOD | ACCEPTABLE | GOOD | INVENTION |
| | | | | | EXAMPLE |
| P7 | ACCEPTABLE | NOT | ACCEPTABLE | GOOD | COMPARATIVE |
| | | ACCEPTABLE | | | EXAMPLE |
| P8 | ACCEPTABLE | ACCEPTABLE | GOOD | GOOD | INVENTION |
| | | | | | EXAMPLE |
| P9 | GOOD | GOOD | GOOD | GOOD | INVENTION |
| | | | | | EXAMPLE |
| P10 | GOOD | ACCEPTABLE | GOOD | GOOD | INVENTION |
| | | | | | EXAMPLE |
| P11 | ACCEPTABLE | NOT | GOOD | GOOD | COMPARATIVE |
| | | ACCEPTABLE | | | EXAMPLE |
| P12 | GOOD | NOT | GOOD | GOOD | COMPARATIVE |
| | | ACCEPTABLE | | | EXAMPLE |
| P13 | NOT | ACCEPTABLE | GOOD | GOOD | COMPARATIVE |
| | ACCEPTABLE | | | | EXAMPLE |
| P14 | ACCEPTABLE | NOT | GOOD | GOOD | COMPARATIVE |
| | | ACCEPTABLE | | | EXAMPLE |
| P15 | ACCEPTABLE | ACCEPTABLE | GOOD | GOOD | INVENTION |
| | | | | | EXAMPLE |
| P16 | ACCEPTABLE | ACCEPTABLE | GOOD | GOOD | INVENTION |
| | | | | | EXAMPLE |
| P17 | ACCEPTABLE | ACCEPTABLE | GOOD | GOOD | INVENTION |
| | | | | | EXAMPLE |
| P18 | ACCEPTABLE | NOT | GOOD | GOOD | COMPARATIVE |
| | | ACCEPTABLE | | | EXAMPLE |
| P19 | ACCEPTABLE | NOT | GOOD | GOOD | COMPARATIVE |
| | | ACCEPTABLE | | | EXAMPLE |
| P20 | GOOD | ACCEPTABLE | GOOD | GOOD | INVENTION |
| | | | | | EXAMPLE |
| P21 | GOOD | ACCEPTABLE | GOOD | GOOD | INVENTION |
| | | | | | EXAMPLE |
| P22 | GOOD | NOT | GOOD | GOOD | COMPARATIVE |
| | | ACCEPTABLE | | | EXAMPLE |
| P23 | NOT | ACCEPTABLE | GOOD | GOOD | COMPARATIVE |
| | ACCEPTABLE | NOT | | | EXAMPLE |
| P24 | NOT | NOT | GOOD | GOOD | COMPARATIVE |
| | ACCEPTABLE | ACCEPTABLE | | | EXAMPLE |
| P25 | ACCEPTABLE | ACCEPTABLE | GOOD | GOOD | INVENTION |
| | | | | | EXAMPLE |
| P26 | ACCEPTABLE | ACCEPTABLE | GOOD | GOOD | INVENTION |
| | | | | | EXAMPLE |
| P27 | ACCEPTABLE | ACCEPTABLE | NOT | GOOD | COMPARATIVE |
| | | | ACCEPTABLE | | EXAMPLE |
| P28 | ACCEPTABLE | ACCEPTABLE | GOOD | GOOD | INVENTION |
| | | | | | EXAMPLE |
| P29 | ACCEPTABLE | ACCEPTABLE | NOT | GOOD | COMPARATIVE |
| | | | ACCEPTABLE | | EXAMPLE |
| P30 | ACCEPTABLE | NOT | ACCEPTABLE | GOOD | COMPARATIVE |
| | | ACCEPTABLE | | | EXAMPLE |
| P31 | GOOD | GOOD | GOOD | GOOD | INVENTION |
| | | | | | EXAMPLE |
| P32 | GOOD | GOOD | GOOD | GOOD | INVENTION |
| | | | | | EXAMPLE |
| P33 | GOOD | GOOD | GOOD | GOOD | COMPARATIVE |
| | | | | | EXAMPLE |
| P34 | GOOD | GOOD | GOOD | GOOD | COMPARATIVE |
| | | | | | EXAMPLE |
| P35 | GOOD | GOOD | GOOD | GOOD | INVENTION |
| | | | | | EXAMPLE |
| P36 | GOOD | GOOD | GOOD | GOOD | INVENTION |
| | | | | | EXAMPLE |
| P37 | GOOD | GOOD | GOOD | GOOD | INVENTION |
| | | | | | EXAMPLE |
| P38 | GOOD | GOOD | GOOD | GOOD | COMPARATIVE |
| | | | | | EXAMPLE |
| P39 | GOOD | GOOD | GOOD | GOOD | COMPARATIVE |
| | | | | | EXAMPLE |
| P40 | GOOD | GOOD | GOOD | GOOD | INVENTION |
| | | | | | EXAMPLE |
| P41 | GOOD | GOOD | GOOD | GOOD | INVENTION |
| | | | | | EXAMPLE |
| P42 | GOOD | GOOD | GOOD | GOOD | INVENTION |
| | | | | | EXAMPLE |
| P43 | GOOD | GOOD | GOOD | GOOD | COMPARATIVE |
| | | | | | EXAMPLE |
| P44 | GOOD | GOOD | GOOD | GOOD | COMPARATIVE |
| | | | | | EXAMPLE |
| P45 | GOOD | GOOD | GOOD | GOOD | INVENTION |
| | | | | | EXAMPLE |
| P46 | GOOD | GOOD | GOOD | GOOD | INVENTION |
| | | | | | EXAMPLE |
| P47 | GOOD | GOOD | GOOD | GOOD | INVENTION |
| | | | | | EXAMPLE |
| P48 | GOOD | GOOD | GOOD | GOOD | COMPARATIVE |
| | | | | | EXAMPLE |
| P49 | GOOD | GOOD | GOOD | GOOD | COMPARATIVE |
| | | | | | EXAMPLE |
| P50 | GOOD | GOOD | GOOD | GOOD | INVENTION |
| | | | | | EXAMPLE |
| P51 | GOOD | GOOD | GOOD | GOOD | INVENTION |
| | | | | | EXAMPLE |
| P52 | GOOD | GOOD | GOOD | GOOD | INVENTION |
| | | | | | EXAMPLE |
| P53 | GOOD | GOOD | GOOD | GOOD | COMPARATIVE |
| | | | | | EXAMPLE |
| P54 | GOOD | GOOD | GOOD | GOOD | COMPARATIVE |
| | | | | | EXAMPLE |
| P55 | GOOD | GOOD | GOOD | GOOD | INVENTION |
| | | | | | EXAMPLE |
| P56 | GOOD | GOOD | GOOD | GOOD | INVENTION |
| | | | | | EXAMPLE |
| P57 | ACCEPTABLE | ACCEPTABLE | GOOD | ACCEPTABLE | INVENTION |
| | | | | | EXAMPLE |
| P58 | ACCEPTABLE | ACCEPTABLE | GOOD | ACCEPTABLE | INVENTION |
| | | | | | EXAMPLE |
| P59 | ACCEPTABLE | ACCEPTABLE | GOOD | ACCEPTABLE | INVENTION |
| | | | | | EXAMPLE |
| P60 | GOOD | GOOD | GOOD | ACCEPTABLE | INVENTION |
| | | | | | EXAMPLE |
| P61 | GOOD | GOOD | GOOD | ACCEPTABLE | INVENTION |
| | | | | | EXAMPLE |
| P62 | GOOD | GOOD | GOOD | ACCEPTABLE | INVENTION |
| | | | | | EXAMPLE |
| P63 | ACCEPTABLE | NOT | GOOD | GOOD | COMPARATIVE |
| | | ACCEPTABLE | | | EXAMPLE |
| P64 | ACCEPTABLE | NOT | GOOD | GOOD | COMPARATIVE |
| | | ACCEPTABLE | | | EXAMPLE |
| P65 | ACCEPTABLE | NOT | GOOD | GOOD | COMPARATIVE |
| | | ACCEPTABLE | | | EXAMPLE |
| P66 | GOOD | GOOD | GOOD | NOT | COMPARATIVE |
| | | | | ACCEPTABLE | EXAMPLE |
| P67 | ACCEPTABLE | ACCEPTABLE | GOOD | ACCEPTABLE | INVENTION |
| | | | | | EXAMPLE |
| P68 | GOOD | GOOD | GOOD | ACCEPTABLE | INVENTION |
| | | | | | EXAMPLE |
| P69 | GOOD | GOOD | GOOD | ACCEPTABLE | INVENTION |
| | | | | | EXAMPLE |
| P70 | GOOD | GOOD | GOOD | NOT | COMPARATIVE |
| | | | | ACCEPTABLE | EXAMPLE |
| P71 | GOOD | GOOD | GOOD | GOOD | INVENTION |
| | | | | | EXAMPLE |
| P72 | ACCEPTABLE | NOT | GOOD | GOOD | COMPARATIVE |
| | | ACCEPTABLE | | | EXAMPLE |
| P73 | GOOD | GOOD | GOOD | ACCEPTABLE | COMPARATIVE |
| | | | | | EXAMPLE |
| P74 | GOOD | GOOD | GOOD | ACCEPTABLE | COMPARATIVE |
| | | | | | EXAMPLE |

Each underline indicates that the result is outside the range of the present invention.
*1 Criteria for determining the degree of film wrinkle degree in film-laminated metal sheet.
The degree of wrinkles on the film-laminated metal sheet on the outer surface side of the resin-metal laminated panel was determined based on the following criteria.
Good: There are wrinkle marks on the surface of the outer surface side of the resin-metal laminated panel, but the wrinkles are not uneven enough to get caught on a fingemail.
Acceptable: There are no wrinkle marks on the surface of the outer surface side of the resin-metal laminated panel.
Not acceptable: There are film wrinkles on the surface of the outer surface side of the resin-metal laminated panel that are high enough to get caught on a fingernail.
*2 Film-laminated steel sheet film cuttability
The cuttability of the film was determined when the film-laminated steel sheet was punched out with a coupon having φ 50 mm using a press with the film surface of the film-laminated steel sheet serving as a punched outer surface side.
Good: No film sag, thread-like film waste, or film peeling occurs at a punched cut portion.
Acceptable: Film sag or thread-like film waste occurs at a punched cut portion, but there is no film peeling.
Not acceptable: The film at a punched cut end surface portion peels off.
*3 Criteria for determining the peel strength in resin-film laminated metal sheet on laminated panel.
The resin-metal laminated panel was cut with a high-speed precision cutting machine to fabricate a 25 mm wide × 150 mm test piece, the resin film-laminated metal sheets on both surfaces of the end of the test piece were peeled off for about 30 mm to be pinched with chucks of a tensile tester, the peel strength between the film-laminated metal sheet and the urethane resin was measured when the film- laminated metal sheet was peeled off for 100 mm at a tensile speed of 200 mm/min, and the peel strength of the resin film-laminated metal sheet of the laminated panel was determined.
Good: 10 N/25 mm less than or equal to (laminated metal sheet peel strength)
Acceptable: 5 N/25 mm less than or equal to (laminated metal sheet peel strength) <10 N/25 mm
Not acceptable: (laminated metal sheet peel strength) <5 N/25 mm
(the peel strength of 5 N/25 mm or more corresponds to the minimum peel strength required to prevent the panel skin material and the core layer from peeling off when a 20 kg polyethylene tank is dropped from a height of 30 cm from the top of the panel)
*4 Criteria for determining impact resistance in laminated panel.
In the impact resistance test, a test piece having a size of 50 mm × 200 mm cut and collected from the resin-metal laminated panel using a high-speed precision cutting machine was set in a DuPont impact tester equipped with a die including a roll-shaped support part with a distance between support points of 100 mm and a radius of 2.5 mm at the tip of the support part, and a semi-cylindrical punch with a radius of 5 mm as an impact indenter, a 1 kg weight was dropped from a height of 60 mm from an impact receiving surface on top of the impact indenter, and the impact resistance was determined to be good or bad by whether the test piece did not buckle or buckled.
Good: There is no dent, no buckling, or no peeling of the skin material
Acceptable: There are some dents, no buckling, and local peeling of the skin material at a portion hit by the impact indenter
Not acceptable: There is buckling or peeling of the skin material
*5 Criteria for determining dent resistance in laminated panel.
A sample having a size of 5 cm × 5 cm was cut and collected from the resin-metal laminated panel using a high-speed precision cutting machine, a dent impact was applied to the center of the laminated panel sample using a DuPont impact tester (punch tip diameter = 12.5 mm, falling weight condition = 300 g × 40 mm high), and whether the dent resistance is good or bad was determined by the degree of deformation of the skin metal sheet.
Good: The diameter of a dent portion of the resin film-laminated metal sheet of a panel sample skin is less than 2 mm.
Acceptable: The diameter of a dent portion of the resin film-laminated metal sheet of a panel sample skin is 2 mm or more and less than 5 mm.
Not acceptable: The diameter of a dent portion of the resin film-laminated metal sheet of a panel sample skin is 5 mm or more.
*6 Criteria for evaluating the bending resistance of laminated panel at high temperature(80° C.).
The evaluation of the bending resistance of the panel was performed by measuring the bending rigidity of the panel in a stroke.load diagram in a three-point bending test.
The test was performed by setting the temperature in the thermostatic chamber to room temperature and 80° C., the test piece was set on a three-point bending test jig, and the test was performed 10 minutes after the temperature of the thermostatic chamber reached a predetermined temperature.
In the bending rigidity test, the slope of a straight line portion in the elastic deformation region of the stroke.load diagram was found when of a resin-metal composite panel test piece having a size of 50 mm wide and 200 mm long cut with a high-speed precision cutter, the center portion between support points with a distance of 100 mm between the support points was pressed toward the compression side with a semi-cylindrical punch with a punch tip diameter of 25 mm at a punch stroke speed of 50 mm/min while using a tensile tester equipped with a thermostatic chamber, and thereby the bending riaidity was measured.
Good: The bending rigidity of the panel at 80° C. is 80% or more of the bending rigidity at room temperature
Acceptable: The bending rigidity of the panel at 80° C. is 50% or more and less than 80% of the bending rigidity at room temperature
Not acceptable: The bending rigidity of the panel at 80° C. is less than 50% of the bending rigidity at room temperature

Specifics are as follows.

The forming materials that form the resin-metal composite panel are described below.

### [Metal Sheet]

Metal sheets in M1 to M31 illustrated in Table 1 were used.

M1 to M25 are an example where the metal sheet was a cold-rolled steel sheet, and M1 to M5 are an example of a steel sheet that had a coating film of chromium oxide and hydrated oxide generated on its surface by a dichromic acid immersion treatment.

M6 to M7 are an example of a steel sheet in which a cold-rolled steel sheet was subjected to a cathode electrolytic treatment in a chromic anhydride to generate a metallic chromium layer on its surface and further generate chromium oxide and hydrated oxide thereon.

M8 to M13 are an example of a steel sheet in which a cold-rolled steel sheet was subjected to a cathode electrolytic treatment in a Zr fluoride, nitric acid-based treatment solution to generate Zr oxide and Zr hydrated oxide on its surface.

M14 to M15 are an example of a steel sheet in which a cold-rolled steel sheet was subjected to a cathode electrolytic treatment in a Ti fluoride, nitric acid-based treatment solution to generate Ti oxide and Ti hydrated oxide on its surface.

M16 is an example of a steel sheet in which a cold-rolled steel sheet was subjected to a tungstic acid immersion treatment to generate W oxide and W hydrated oxide on its surface.

M17 to M18 are an example of a steel sheet that was subjected to a cathode electrolytic treatment in a nitric acid-based Ce treatment solution to generate Ce oxide and Ce hydrated oxide on its surface.

M19 to M22 are an example of a steel sheet that was subjected to a coating silica treatment to generate SiO₂ on its surface.

M23 is an example of a steel sheet in which a cold-rolled steel sheet was subjected to a tannic acid treatment.

M24 is an example of a steel sheet in which a cold-rolled steel sheet was subjected to a silane coupling treatment.

M25 is an example of a metal sheet obtained by subjecting a SUS304 bright annealed material to a dichromic acid immersion treatment.

M26 to M29 are an example of a metal sheet obtained by subjecting an aluminum sheet to a dichromic acid immersion treatment.

M30 is an example of a cold-rolled steel sheet without a conversion treatment.

### [Thermoplastic Resin Film]

Films in F1 to F27 illustrated in Table 2 were used to fabricate resin film-laminated metal sheets.

F1 to F5 are an example of a thermoplastic stretched homo-PET (polyethylene terephthalate resin) film.

F6 to F10 are an example of a thermoplastic stretched PET-IA (polyethylene terephthalate⋅isophthalate 8 mol % copolymer resin) film.

F11 to F15 are an example of a thermoplastic stretched PET-PBT (polyethylene terephthalate⋅polybutylene terephthalate 50 mass % copolymer resin) film.

F16 to F20 are an example of a PE (polyethylene) resin film with thermoplastic non-stretched modified resin layer.

F21 to F25 are an example of an ethylene-propylene copolymer resin film with thermoplastic non-stretched modified resin layer.

F26 is an example of a thermoplastic non-stretched ionomer-based resin film.

F27 is an example of a thermoplastic non-stretched vinyl chloride resin film.

### [Urethane Core Layer of the Resin-Metal Laminated Panel]

The urethane core layer of the resin-metal laminated panel has the components, thickness, density, and dynamic elastic modulus at 80° C. and 1 Hz illustrated in Table 3.

### [Resin-Metal Laminated Panel]

A laminated metal sheet obtained by thermally laminating the resin film illustrated in Table 2 to the metal sheet illustrated in Table 1 was cut into pieces each having a size of 200 mm×250 mm and each was set on an upper side and a lower side of an injection mold. Then, the mold was filled with a urethane raw material of the component illustrated in Table 3 through an injection opening on a lateral side of the mold while the urethane raw material being mixed, and the mold was held at a pressure of 20 kN/m² for about 30 seconds. Thereafter, the upper and lower molds were opened, and thereby a resin-metal laminated panel illustrated in the left column of Table 4, which has the thickness, density, and dynamic elastic modulus at 80° C. and 1 Hz of the urethane core layer illustrated in Table 3, was obtained.

### [Determination Results of Resin-Metal Laminated Panel Properties]

The determination results of the panel properties of the resin-metal laminated panel obtained above are illustrated in the right columns in Table 4.

Whether the resin-metal laminated panel properties are good or bad was determined by the following methods.

### (1) Determination of the Degree of Film Wrinkles on the Film-Laminated Metal Sheet

The degree of wrinkles on the film-laminated metal sheet on the outer surface side of the resin-metal laminated panel was determined based on the following criteria.

Good: There are wrinkle marks on the surface of the outer surface side of the resin-metal laminated panel, but the wrinkles are not uneven enough to get caught on a fingernail.

Acceptable: Film sag or thread-like film waste occurs at a punched cut portion, but there is no film peeling.

Not acceptable: There are film wrinkles on the surface of the outer surface side of the resin-metal laminated panel that are high enough to get caught on a fingernail.

### (2) Film Cuttability of the Film-Laminated Steel Sheet

The cuttability of the film was determined when the film-laminated steel sheet was punched out with a coupon having φ50 mm using a press with the film surface of the film-laminated steel sheet serving as a punched outer surface side.

Good: No film sag, thread-like film waste, or film peeling occurs at a punched cut portion.

Acceptable: Film sag or thread-like film waste occurs at a punched cut portion, but there is no film peeling.

Not acceptable: The film at a punched cut end surface portion peels off.

### (3) Determination of the Peel Strength of the Resin Film-Laminated Metal Sheet of the Laminated Panel]

The resin-metal laminated panel illustrated in Table 4 was cut with a high-speed precision cutting machine to collect a test piece having a size of 25 mm wide×150 mm. The resin film-laminated metal sheets on both surfaces of the end of the test piece were peeled off for about 30 mm to fabricate grip parts to be pinched with chucks of a tensile tester.

The grip parts of the resin film-laminated metal sheets on both surfaces of the test piece were pinched with the chucks of the tensile tester to peel off the resin film-laminated metal sheets for 100 mm at a tensile speed of 200 mm/min (movement distance between the chucks of 200 mm), and the peel strength between the resin film-laminated metal sheet and the foamed hard urethane resin of the core layer (laminated metal sheet peel strength) was measured. The peel strength when the resin film-laminated metal sheet was peeled off for 100 mm was determined based on the following criteria. A pass was given when the peel strength was evaluated to be acceptable or better. The results obtained are illustrated in Table 3 and Table 4.

Good: 10 N/25 mm≤(laminated metal sheet peel strength)

Acceptable: 5 N/25 mm≤(laminated metal sheet peel strength)<10 N/25 mm

Not acceptable: (laminated metal sheet peel strength)<5 N/25 mm

### (4) Laminated Panel Impact Resistance Determination

In the impact resistance test, a test piece having a size of 50 mm×200 mm was cut and collected from the resin-metal laminated panel using a high-speed precision cutting machine. The obtained test piece was set in a DuPont impact tester equipped with a die including a roll-shaped support part with a distance between support points of 100 mm and a radius of 2.5 mm at the tip of the support part, and a semi-cylindrical punch with a radius of 5 mm as an impact indenter, and a 1 kg weight was dropped from a height of 60 mm from an impact receiving surface on top of the impact indenter. The impact resistance was determined to be good or bad by whether the test piece did not buckle or buckled.

Good: There is no dent, no buckling, or no peeling of the skin material

Acceptable: There are some dents, no buckling, and local peeling of the skin material at a portion hit by the impact indenter

Not acceptable: There is buckling or peeling of the skin material

### (5) Laminated Panel Dent Resistance Determination

A sample having a size of 5 cm×5 cm was cut and collected from the resin-metal laminated panel using a high-speed precision cutting machine. A dent impact was applied to the center of the laminated panel sample using a DuPont impact tester (punch tip diameter=12.5 mm, falling weight condition=300 g×40 mm high), and whether the dent resistance is good or bad was determined by the degree of deformation of the sample.

Good: The diameter of a dent portion of the resin film-laminated metal sheet of a panel sample skin is less than 2 mm.

Acceptable: The diameter of a dent portion of the resin film-laminated metal sheet of a panel sample skin is 2 mm or more and less than 5 mm.

Not acceptable: The diameter of a dent portion of the resin film-laminated metal sheet of a panel sample skin is 5 mm or more.

### (6) High-Temperature (80° C.) Panel Bending Resistance Evaluation Determination

The evaluation of the bending resistance of the panel was performed by measuring the bending rigidity of the panel in a stroke-load diagram in a three-point bending test. In the bending rigidity test, of a resin-metal composite panel test piece having a size of 50 mm wide and 200 mm long cut with a high-speed precision cutter, the center portion between support points with a distance of 100 mm between the support points was pressed toward the compression side with a semi-cylindrical punch with a punch tip diameter of 25 mm at a punch stroke speed of 50 mm/min while using a tensile tester equipped with a thermostatic chamber. The bending rigidity was measured by finding the slope of a straight line portion in the elastic deformation region of the stroke-load diagram during pressing. The test was performed by setting the temperature in the thermostatic chamber to room temperature and 80° C., the test piece was set on a three-point bending test jig, and the test was performed 10 minutes after the temperature of the thermostatic chamber reached a predetermined temperature.

Good: The bending rigidity of the panel at 80° C. is 80% or more of the bending rigidity at room temperature

Acceptable: The bending rigidity of the panel at 80° C. is 50% or more and less than 80% of the bending rigidity at room temperature

Not acceptable: The bending rigidity of the panel at 80° C. is less than 50% of the bending rigidity at room temperature

As can be seen from Table 4, the resin-metal composite panel having the composition in the present invention exhibits excellent panel properties.

The preferred embodiment of the present invention has been described in detail above with reference to the attached drawings, but the present invention is not limited to such an example. It is apparent that a person having common knowledge in the technical field to which the present invention belongs is able to devise various variation or modification examples within the range of technical ideas described in the claims, and it should be understood that such examples belong to the technical scope of the present invention as a matter of course.

The embodiment disclosed herein is an example in all respects and should not be considered to be restrictive. The above-described embodiment may be omitted, substituted, or modified in various forms without departing from the scope of the appended claims and the configuration and gist that fall within the technical scope of the present invention as described below. For example, configuration requirements of the above-described embodiment can be arbitrarily combined within a range that does not impair the effects. Further, the operations and effects about the configuration requirements relating to an arbitrary combination can be obtained as a matter of course from the combination, and those skilled in the art can obtain clear other operations and other effects from the description herein.

Further, the effects explained herein are merely explanatory or illustrative in all respects and not restrictive. That is, the technique relating to the present invention can offer other clear effects to those skilled in the art from the description herein in addition to or in place of the above-described effects.

Note that the following configuration also belongs to the technical scope of the present invention.

(1) A resin-metal composite panel, comprising:
a pair of skin materials made of two metal sheets; and a core resin layer that is located between the pair of skin materials and is formed of a hard urethane resin in a foamed state, wherein
the metal sheet is
a laminated steel sheet including: a steel sheet having a sheet thickness of 0.10 mm or more; a layer located on the surface of the steel sheet on the core resin layer side, having a surface tension of 50 mN/m or more that is measured based on JIS K 6768: 1999, and made of inorganic hydrated oxide and inorganic oxide with an adhesion amount of 1.5 to 130 mg/m²; and a thermoplastic resin layer having a thickness of 8 to 150 μm, located on the surface of the steel sheet opposite to the core resin layer, or
a laminated aluminum sheet including: an aluminum sheet having a sheet thickness of 0.24 mm or more; a layer located on the surface of the aluminum sheet on the core resin layer side, having a surface tension of 50 mN/m or more that is measured based on JIS K 6768: 1999, and made of inorganic hydrated oxide and inorganic oxide with an adhesion amount of 1.5 to 130 mg/m²; and a thermoplastic resin layer having a thickness of 8 to 150 μm, located on the surface of the aluminum sheet opposite to the core resin layer, and
the hard urethane resin has a thickness of 3 mm or more, a dynamic longitudinal elastic modulus measured at 80° C. and 1 Hz of 100 MPa or more, and a density of 0.2 to 0.7 g/cm³.
   (2) The resin-metal composite panel according to (1), wherein
the inorganic hydrated oxide and inorganic oxide are one or two or more selected from the group consisting of chromium hydrated oxide and chromium oxide, zirconium hydrated oxide and zirconium oxide, titanium hydrated oxide and titanium oxide, tungsten hydrated oxide and tungsten oxide, cerium hydrated oxide and cerium oxide, and silica.
   (3) The resin-metal composite panel according to (1) or (2), wherein
a surface tension of the thermoplastic resin layer is 40 mN/m or more.
   (4) The resin-metal composite panel according to any one of (1) to (3), wherein
the thermoplastic resin layer contains one or two or more selected from the group consisting of a thermoplastic polyester resin, a polyethylene resin with modified resin layer, a polypropylene resin with modified resin layer, an ethylene-propylene copolymer resin with modified resin layer, an ionomer resin, and a polyvinyl chloride resin.

### INDUSTRIAL APPLICABILITY

The resin-metal laminated panel in the present invention is extremely useful as laminated lightweight panels for floor and wall materials of building materials, ships, and vehicles because the adhesive strength of the laminated panel with the core layer is high and the rigidity of the panel is high, and further, the laminated panel can be manufactured inexpensively.

1. A resin-metal composite panel being a resin-metal composite panel formed by injecting and foaming a hard urethane resin between skin materials made of two metal sheets, wherein
the skin material is
a single-sided film-laminated steel sheet having a steel sheet thickness of 0.1 mm or more, the single-sided film-laminated steel sheet including: a thermoplastic resin layer having a film thickness of 8 μm to 150 μm on a panel outer surface side; and a layer having a surface tension of 50 mN/m or more as a surface tension measured based on JIS K 6768: 1999, the layer made of inorganic hydrated oxide and inorganic oxide with an adhesion amount of 1.5 to 130 mg/m² on an inner surface side to be bonded to a core resin layer, or
a single-sided film-laminated aluminum sheet having an aluminum sheet thickness of 0.24 mm or more, the single-sided film-laminated aluminum sheet including: a thermoplastic resin layer having a film thickness of 8 μm to 150 μm on a panel outer surface side; and a layer having a surface tension of 50 mN/m or more as a surface tension measured based on JIS K 6768: 1999, the layer made of inorganic hydrated oxide and inorganic oxide with an adhesion amount of 1.5 to 130 mg/m² on an inner surface side to be bonded to a core resin layer, and
the hard urethane resin of the core resin layer has a thickness of 3 mm or more, a dynamic longitudinal elastic modulus measured at 80° C. and 1 Hz of 100 MPa or more, and a density of the hard foamed urethane resin after foaming of 0.2 to 0.7 g/cm³.

2. The resin-metal composite panel according to claim 1, wherein
the inorganic hydrated oxide and inorganic oxide on the skin material are inorganic hydrated oxide and inorganic oxide containing one or more of chromium hydrated oxide and chromium oxide, zirconium hydrated oxide and zirconium oxide, titanium hydrated oxide and titanium oxide, tungsten hydrated oxide and tungsten oxide, cerium hydrated oxide and cerium oxide, and silica.

3. The resin-metal composite panel according to claim 1, wherein
a thermoplastic film having a surface tension of 40 mN/m or more is thermally fusion-bonded to the panel outer surface side of the single-sided film-laminated steel sheet or the single-sided film-laminated aluminum sheet.

4. The resin-metal composite panel according to claim 3, wherein
the thermoplastic film is a resin blended with one or more of a thermoplastic polyester resin, a polyethylene resin with modified resin layer, a polypropylene resin with modified resin layer, an ethylene propylene copolymer resin with modified resin layer, an ionomer resin, and a polyvinyl chloride resin.

5. The resin-metal composite panel according to claim 2, wherein
a thermoplastic film having a surface tension of 40 mN/m or more is thermally fusion-bonded to the panel outer surface side of the single-sided film-laminated steel sheet or the single-sided film-laminated aluminum sheet.

6. The resin-metal composite panel according to claim 5, wherein
the thermoplastic film is a resin blended with one or more of a thermoplastic polyester resin, a polyethylene resin with modified resin layer, a polypropylene resin with modified resin layer, an ethylene propylene copolymer resin with modified resin layer, an ionomer resin, and a polyvinyl chloride resin.
